(19) United States
(12) Patent Application Publication
(10) Pub. No.: US 2026/0303630 A1
(43) Pub. Date: Oct. 1, 2026

(54) MACHINE LEARNING ASSISTED NETWORK DETECTION AND RESPONSE

(71) Applicant: Sophos Limited, Abingdon (GB)

(72) Inventors: Anoop Kodakkal Valappil, Bangalore (IN); Laxmikant Agarwal, Bangalore (IN); Nishit Shantibhai Shah, Ahmedabad (IN); Bobby Cheuk-Yuen Lam, Richmond (CA); Andrew J. Thomas, Long Wittenham (GB)

(21) Appl. No.: 19/255,033

(22) Filed: Jun. 30, 2025

(30) Foreign Application Priority Data
Mar. 31, 2025 (IN) 202511031684

(51) Int. Cl. H04L 9/40

(52) U.S. Cl. CPC H04L 63/1425; H04L 63/0254; H04L 63/1433

(57) ABSTRACT

A method for responding to a threat includes receiving, by a firewall of a monitored network system, network traffic, providing, by the firewall, filtered metadata associated with a portion of the network traffic to a remote machine learning model for analysis, receiving, by the firewall, a response from the remote machine learning model based on the analysis, and enforcing, by the firewall, the response from the remote machine learning model on the received network traffic with an action.

### RELATED APPLICATION

This application claims priority to Indian Provisional Patent Application No. 202511031684, filed on Mar. 31, 2025 and titled “Machine Learning Assisted Network Detection and Response” the entirety of which is incorporated by reference herein.

### FIELD

The present disclosure relates generally to firewall cyber security, and more particularly, machine learning-assisted Network Detection and Response (NDR).

### BACKGROUND

From the discovery of the Morris Worm, the first known malware to today's complex, multi-stage attacks, the malicious actors continue to evolve and innovate their tactics, forcing the cybersecurity community to try to stay ahead with anti-malware solutions that will catch the new behaviors in the act before data can be exfiltrated, ransom demands can be made, or a breach is successful. The cybersecurity industry began with the notion of prevention but has evolved to become more reactive in posture. Today, the industry focus is towards investment in detection and response which has come in the form of endpoint detection and response (EDR), network detection and response (NDR), managed detection and response (MDR), and extended detection and response (XDR).

NDR is a cybersecurity approach that uses machine learning and behavioral analytics to continuously monitor network traffic for suspicious activity, enabling organizations to identify and respond to potential threats within their network infrastructure. NDR may incorporate both machine learning and traditional deep packet inspection (DPI) on raw network traffic. At present, NDR has been deployed on customer cloud networks or as physical appliances connected to a mirrored port on a customer network. However, NDR approaches have not been deployed directly on a firewall system.

As such, systems and methods for enhancing NDR with machine learning capabilities by integrating such capabilities directly into a firewall, would be well received in the art.

### SUMMARY

According to embodiments, disclosed herein are various methods and associated computer systems and computer program products for responding to threats.

In one embodiment, a firewall of a monitored network system receives network traffic and provides filtered metadata associated with a portion of the network traffic to a remote machine learning model for analysis. The firewall receives a response from the remote machine learning model based on the analysis and enforces the response from the remote machine learning model on the received network traffic with an action.

In other embodiments, a firewall of a monitored network receives network traffic. The firewall extracts metadata associated with the network traffic and provides the metadata associated with the network traffic to a machine learning model for analysis. The firewall receives a response from the machine learning model based on the analysis. The firewall performs one or more threat analyses on the network traffic asynchronously with the analysis by the remote machine learning model. The firewall enforces the response from the remote machine learning model on the received network traffic with an action.

In other embodiments, a firewall of a monitored network system receives network traffic. A packet analysis system located within the firewall inline prepares flow metadata associated with the network traffic. The packet analysis system provides the network traffic to the firewall for further processing after the inline preparing. The firewall provides the prepared flow metadata associated with the network traffic to a remote machine learning model for analysis. The firewall receives a response from the machine learning model based on the analysis.

In other embodiments, a firewall of a monitored network system receives network traffic. The firewall processes the network traffic using a fast path processing system and accelerates the network traffic by the fast path processing system. A packet analysis system located within the firewall prepares flow metadata associated with the network traffic and the firewall provides the prepared flow metadata to a machine learning model for analysis. The firewall receives a response from the machine learning model based on the analysis.

### BRIEF DESCRIPTION OF THE DRAWINGS

The above and further advantages of this disclosure may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the disclosure.

FIG. 1 depicts a block diagram of an environment for threat management, according to an example embodiment.

FIG. 2 depicts an architectural schematic view of a firewall system, according to an example embodiment.

FIG. 3 depicts a flow chart for performing a lookup by a consumer, according to an example embodiment.

FIG. 4 depicts a user interface for a firewall system, according to an example embodiment.

FIG. 5 depicts a flow chart for a method for responding to a threat, according to an example embodiment.

FIG. 6 depicts a flow chart for a method of responding to a ML model analysis of network traffic, according to an example embodiment.

FIG. 7 depicts a flow chart for a method of interfacing with a firewall system connected to a ML model, according to an example embodiment.

FIG. 8 depicts a flow chart for a method for responding to a threat, according to an example embodiment.

FIG. 9 depicts an architectural schematic view of a packet processing system of a firewall system, according to an example embodiment.

FIG. 10 depicts an architectural schematic view of instances of a metadata processing system of a firewall system, according to an example embodiment.

FIG. 11 depicts another architectural schematic view of a metadata processing system of a firewall system, according to an example embodiment.

FIG. 12 depicts an ingress and egress process in event mode for a firewall system, according to an example embodiment.

FIG. 13 depicts an ingress process in poll mode for a firewall system, according to an example embodiment.

FIG. 14 depicts a flow chart for a method for responding to a threat, according to an example embodiment.

FIG. 15 depicts a flow chart for preparing flow metadata for ML analysis, according to an example embodiment.

FIG. 16 depicts a flow chart for a filtering process for filtering prepared flow metadata for ML analysis, according to an example embodiment.

FIG. 17 depicts a flow chart for creating multiple instances of a packet analysis system of a firewall system, according to an example embodiment.

FIG. 18 depicts a flow chart for a method for responding to a threat, according to an example embodiment.

FIG. 19 depicts a diagram of an example computing device, according to an example embodiment.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure as described herein.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms.

It should also be understood that endpoints, devices, compute instances or the like that are referred to as “within” an enterprise network may also be “associated with” the enterprise network, e.g., where such assets are outside an enterprise gateway but nonetheless managed by or in communication with a threat management facility or other centralized security platform for the enterprise network. Thus, any description referring to an asset within the enterprise network should be understood to contemplate a similar asset associated with the enterprise network regardless of location in a network environment unless a different meaning is explicitly provided or otherwise clear from the context.

Embodiments herein are directed to methods and computer systems configured to respond to a threat in the cyber security context with endpoint (i.e. host, device and/or user) isolation. As contemplated herein, computers, and their central management system, upon detecting or otherwise receiving information indicating a threat to an endpoint, may perform a global isolation of the endpoint across various network devices and/or products within the network to block a device identifier or user identification associated with the endpoint that is responsible for the threat.

The present disclosure endeavors to incorporate machine learning (ML) capabilities, and deep packet inspection (DPI) on raw network traffic, directly into firewall systems in order to stop malicious threats over a monitored network. Prior to the present disclosure, network detection and response (NDR) systems have deployed various systems on customer cloud networks or as physical appliances connected to mirrored ports on a customer network. However, the present disclosure aims to integrate these NDR features directly into a firewall system.

Thus, embodiments described herein are configured to leverage ML to take action (e.g., log only and/or log and drop) on traffic flowing through a firewall system. Embodiments described herein contemplate that the ML models which perform the encrypted payload analytics (EPA) analysis for encrypted traffic, and domain generated algorithm (DGA) analysis for domain names. In embodiments contemplated, the ML models may be running in a remote cloud location relative to the monitored network and/or firewall system. Further, the remote cloud systems running the ML models may further include a customized scoring engine and/or algorithm and/or model.

The output from the monitored network and/or firewall system to these remote ML models running in the cloud may be metadata of the connections and network traffic which needs to be analyzed. In order to generate the appropriate metadata in an efficient and resource conscious manner, embodiments contemplated herein include providing the firewall system with a new NDR service running in the firewall system that can send such metadata to the cloud. Moreover, the firewall system may include an additional fastpath component which will process the packets and prepare the metadata per TLS/DNS connection.

As contemplated herein, after receiving and processing the response from ML models (e.g., remote and/or cloud services), whichever indicators of compromise (IoCs) beyond the configured threat score will be updated in the IPSet and shared memory of the new NDR service running in the firewall. Various consumer services in the firewall system, such as Layer 3 firewall functionality, intrusion prevention systems (IPS), domain name systems (DNS), Web proxy and transport layer security (TLS), may lookup into these NDR IoC threat feeds to take action on new connections and/or network traffic.

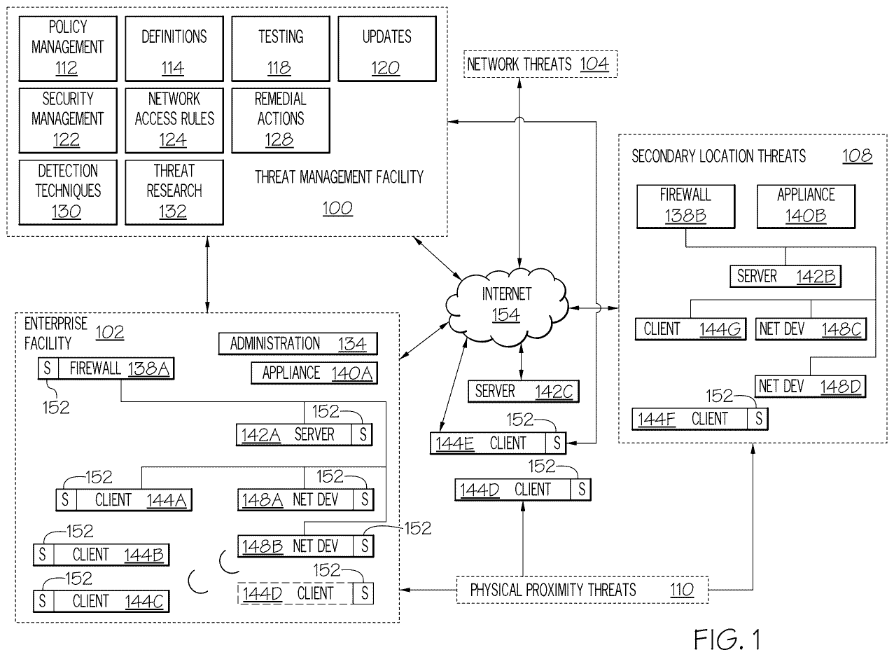

FIG. 1 illustrates an environment for threat management, according to an example embodiment. Specifically, FIG. 1 depicts a block diagram of a threat management facility 100 providing protection to one or more enterprises, networks, locations, users, businesses, etc. against a variety of threats—a context in which the techniques described herein may usefully be deployed. The threat management facility 100 may represent any threat management system, such as the threat management systems described herein below.

The threat management facility 100 may be used to protect devices and assets (e.g., IoT devices or other devices) from computer-generated and human-generated threats. For example, a corporation, school, web site, homeowner, network administrator, or other entity may institute and enforce one or more policies that control or prevents certain network users (e.g., employees, residents, users, guests, etc.) from accessing certain types of applications, devices, resources generally or in a particular manner. Policies may be created, deployed and managed, for example, through the threat management facility 100, which may update and monitor network devices, users, and assets accordingly.

The threat of enumeration attacks, malware or other compromises may be present at various points within a network 102 such as laptops, desktops, servers, gateways, communication ports, handheld or mobile devices, IoT devices, firewalls. In addition to controlling or stopping malicious code, a threat management facility 100 may provide policy management to control devices, applications, or users that might otherwise undermine productivity and network performance within the network 102.

The threat management facility 100 may provide protection to network 102 from computer-based malware, including viruses, spyware, adware, Trojans, intrusion, spam, policy abuse, advanced persistent threats, uncontrolled access, and the like. In general, the network 102 may be any networked computer-based infrastructure or the like managed by a threat management facility 100, such as an organization, association, institution, or the like, or a cloud-based facility that is available for subscription by individuals. For example, the network 102 may be a corporate, commercial, educational, governmental, or other network 102, and may include multiple networks, computing resources, and other facilities, may be distributed among more than one geographical location, and may include administration 134, a firewall 138A, an appliance 140A, a server 142A, network devices 148A-B, clients 144A-D, such as IoT devices or other devices. It will be understood that any reference herein to a client or client facilities may include the clients 144A-D shown in FIG. 1 and vice versa.

The threat management facility 100 may include computers, software, or other computing facilities supporting a plurality of functions, such as security management facility 122, policy management facility 112, update facility 120, a definitions facility 114, network access rules facility 124, remedial action facility 128, detection techniques facility 130, testing facility 118, a threat research facility 132, and the like. In embodiments, the threat protection provided by the threat management facility 100 may extend beyond the network boundaries of the network 102 to include clients 144D (or client facilities) that have moved into network connectivity not directly associated with or controlled by the network 102. Threats to client facilities may come from a variety of sources, such as from network threats 104, physical proximity threats 110, secondary location threats 108, and the like. Clients 144A-D may be protected from threats even when the client 144A-D is not directly connected or in association with the network 102, such as when a client 144E-F moves in and out of the network 102, for example when interfacing with an unprotected server 142C through the Internet 154, when a client 144F is moving into a secondary location threat 108 network such as interfacing with components 140B, 142B, 148C, 148D that are not protected, and the like.

The threat management facility 100 may use or may be included in an integrated system approach to provide network 102 protection from a plurality of threats to device resources in a plurality of locations and network configurations. The threat management facility 100 may also or instead be deployed as a stand-alone solution. For example, some or all of the threat management facility 100 components may be integrated into a server or servers at a remote location, for example in a cloud computing facility. For example, some or all of the threat management facility 100 components may be integrated into a firewall, gateway, or access point within or at the border of the network 102. In some embodiments, the threat management facility 100 may be integrated into a product, such as a third-party product, e.g., through an application programming interface, which may be deployed on endpoints, on remote servers, on internal servers or gateways for a network, or some combination of these.

The security management facility 122 may include a plurality of elements that provide protection from malware to network 102 device resources in a variety of ways including endpoint security and control, email security and control, web security and control, reputation-based filtering, control of unauthorized users, control of guest and non-compliant computers, and the like. The security management facility 122 may include a local software application that provides protection to one or more network 10 devices. The security management facility 122 may have the ability to scan client facility files for malicious code, remove or quarantine certain applications and files, prevent certain actions, perform remedial actions and perform other security measures. This may include scanning some or all of the files stored on the client facility or accessed by the client facility on a periodic basis, scanning an application when the application is executed, scanning data (e.g., files or other communication) in transit to or from a device, etc. The scanning of applications and files may be performed to detect known or unknown malicious code or unwanted applications.

The security management facility 122 may provide email security and control. The security management facility 122 may also or instead provide for web security and control, such as by helping to detect or block viruses, spyware, malware, unwanted applications, and the like, or by helping to control web browsing activity originating from client devices. In an embodiment, the security management facility 122 may provide for network access control, which may provide control over network connections. In addition, network access control may control access to virtual private networks (VPN) that provide communications networks tunneled through other networks. The security management facility 122 may provide host intrusion prevention through behavioral based protection, which may guard against known or unknown threats by analyzing behavior before or while code executes. The security management facility 122 may provide reputation filtering, which may target or identify sources of code.

In general, the security management facility 122 may support overall security of the network 102 using the various techniques described above, optionally as supplemented by updates of malicious code information and so forth for distribution across the network 102.

The administration facility 134 may provide control over the security management facility 122 when updates are performed. Information from the security management facility 122 may also be sent from the enterprise back to a third party, a vendor, or the like, which may lead to improved performance of the threat management facility 100.

The threat management facility 100 may include a policy management facility 112 configured to take actions, such as to block applications, users, communications, devices, and so on based on determinations made. The policy management facility 112 may employ a set of rules or policies that determine network 102 access permissions for a client 144. In an embodiment, a policy database may include a block list, a blacklist, an allowed list, a whitelist, or the like, or combinations of the foregoing, that may provide a list of resources internal or external to the network 102 that may or may not be accessed by client devices 144. The policy management facility 112 may also or instead include rule-based filtering of access requests or resource requests, or other suitable techniques for controlling access to resources consistent with a corresponding policy.

The policy management facility 112 may also provide configuration policies to be used to compare and control the configuration of applications, operating systems, hardware, devices, network associated with the network 102. An evolving threat environment may dictate timely updates, and thus an update management facility 120 may also be provided by the threat management facility 100. In addition, a policy management facility 112 may require update management (e.g., as provided by the update facility 120 herein described). In embodiments, the update management facility 120 may provide for patch management or other software updating, version control, and so forth.

The security facility 122 and policy management facility 112 may push information to the network 102 and/or a given client 144. The network 102 and/or client 144 may also or instead request information from the security facility 122 and/or policy management facility 112, network server facilities 142, or there may be a combination of pushing and pulling of information. In an embodiment, the policy management facility 112 and the security facility 122 management update modules may work in concert to provide information to the network 102 and/or client 144 facility for control of applications, devices, users, and so on.

As threats are identified and characterized, the threat management facility 100 may create updates that may be used to allow the threat management facility 100 to detect and remediate malicious software, unwanted applications, configuration and policy changes, and the like. The threat definition facility 114 may contain threat identification updates, also referred to as definition files. A definition file may be a virus identity file that may include definitions of known or potential malicious code. The virus identity definition files may provide information that may identify malicious code within files, applications, or the like. The definition files may be accessed by security management facility 122 when scanning files or applications within the client facility for the determination of malicious code that may be within the file or application. A definition management facility may include a definition for a neural network or other recognition engine. A definition management facility 114 may provide timely updates of definition files information to the network, client facilities, and the like.

The security management facility 122 may be used to scan an outgoing file and verify that the outgoing file is permitted to be transmitted per the enterprise facility 102 rules and policies. By checking outgoing files, the security management facility 122 may be able to discover malicious code infected files that were not detected as incoming files.

The threat management facility 100 may provide controlled access to the network 102. A network access rules facility 124 may be responsible for determining if a client facility 144 application should be granted access to a requested network resource. In an embodiment, the network access rules facility 124 may verify access rights for client facilities 144 to or from the network 102 or may verify access rights of computer facilities to or from external networks. When network access for a client facility is denied, the network access rules facility 124 may send an information file to the client facility, e.g., a command or command file that the remedial action facility 128 may access and take action upon. The network access rules facility 124 may include one or more databases that may include a block list, a blacklist, an allowed list, a white list, a reputation list, an unacceptable network resource database, an acceptable network resource database, a network resource reputation database, or the like. The network access rules facility 124 may incorporate rule evaluation. Rule evaluation may, for example, parse network access requests and apply the parsed information to network access rules. The network access rule facility 124 may also or instead provide updated rules and policies to the enterprise facility 102.

When a threat or policy violation is detected by the threat management facility 100, the threat management facility 100 may perform or initiate remedial action through a remedial action facility 128. Remedial action may take a variety of forms, such as terminating or modifying an ongoing process or interaction, issuing an alert, sending a warning to a client or administration facility 134 of an ongoing process or interaction, executing a program or application to remediate against a threat or violation, record interactions for subsequent evaluation, and so forth. The remedial action may include one or more of blocking some or all requests to a network location or resource, performing a malicious code scan on a device or application, performing a malicious code scan on the client facility 144, quarantining a related application (or files, processes or the like), terminating the application or device, isolating the application or device, moving a process or application code to a sandbox for evaluation, isolating the client facility 144 to a location or status within the network that restricts network access, blocking a network access port from a client facility 144, reporting the application to an administration facility 134, or the like, as well as any combination of the foregoing.

Remedial action may be provided as a result of a detection of a threat or violation. The detection techniques facility 130 may include tools for monitoring the network or managed devices within the network 102. The detection techniques facility 130 may provide functions such as monitoring activity and stored files on computing facilities. Detection techniques, such as scanning a computer's stored files, may provide the capability of checking files for stored threats, either in the active or passive state. Detection techniques such as streaming file management may be used to check files received at the network, a gateway facility, a client facility, and the like.

Verifying that the threat management facility 100 detects threats and violations to established policy, may require the ability to test the system, either at the system level or for a particular computing component. The testing facility 118 may allow the administration facility 134 to coordinate the testing of the security configurations of client facility computing facilities on a network. For example, the administration facility 134 may be able to send test files to a set of client facility computing facilities to test the ability of the client facility to determine acceptability of the test file. After the test file has been transmitted, a recording facility may record the actions taken by the client facility in reaction to the test file. The recording facility may aggregate the testing information from the client facility and report the testing information to the administration facility 134. The administration facility 134 may be able to determine the level of preparedness of the client facility 144 based on the reported information. Remedial action may be taken for any of the client facilities 144 as determined by the administration facility 134.

The threat management facility 100 may provide threat protection across the network 102 to devices such as clients 144, a server facility 142, an administration facility 134, a firewall 138, a gateway, one or more network devices (e.g., hubs and routers 148, a threat management or other appliance 140, any number of desktop or mobile users, and the like. As used herein the term endpoint may refer to any compute instance running on a device that can source data, receive data, evaluate data, buffer data, process data or the like (such as a user's desktop computer, laptop, IoT device, server, etc.). This may, for example, include any client devices as well as other network devices and the like within the network 102, such as a firewall or gateway (as a data evaluation endpoint computer system), a laptop (as a mobile endpoint computer), a tablet (as a hand-held endpoint computer), a mobile phone, or the like. The term endpoint may also or instead refer to any final or intermediate source or destination for data within a network 102. The endpoint computer security facility 152 may be an application locally loaded onto any corresponding computer platform or computer support component, either for local security functions or for management by the threat management facility 100 or other remote resource, or any combination of these.

The network 102 may include a plurality of client facility computing platforms on which the endpoint computer security facility 152 is installed. A client facility computing platform may be a computer system that is able to access a service on another computer, such as a server facility 142, via a network. The endpoint computer security facility 152 may, in corresponding fashion, provide security in any suitable context such as among a plurality of networked applications, for a client facility connecting to an application server facility 142, for a web browser client facility connecting to a web server facility 142, for an e-mail client facility retrieving e-mail from an Internet 154 service provider's mail storage servers 142 or web site, and the like, as well as any variations or combinations of the foregoing.

The network 102 may include one or more of a variety of server facilities 142, such as application servers, communications servers, file servers, database servers, proxy servers, mail servers, fax servers, game servers, web servers, and the like. A server facility 142, which may also be referred to as a server facility 142 application, server facility 142 operating system, server facility 142 computer, or the like, may be any device(s), application program(s), operating system(s), or combination of the foregoing that accepts client facility connections in order to service requests from clients 144. In embodiments, the threat management facility 100 may provide threat protection to server facilities 142 within the network 102 as load conditions and application changes are made.

A server facility 142 may include an appliance facility 140, where the appliance facility 140 provides specific services to other devices on the network. Simple server facility 142 appliances may also be utilized across the network 102 infrastructure, such as switches, routers, hubs, gateways, print servers, modems, and the like. These appliances may provide interconnection services within the network 102, and therefore may advance the spread of a threat if not properly protected.

A client facility 144 may be protected from threats from within the network 102 using a local or personal firewall, which may be a hardware firewall, software firewall, or combination, that controls network traffic to and from a client. The local firewall may permit or deny communications based on a security policy. Another component that may be protected by an endpoint computer security facility 152 is a network firewall facility 138, which may include hardware or software, in a standalone device or integrated with another network component, that may be configured to permit, deny, or proxy data through a network 102.

The interface between the threat management facility 100 and the network 102, and through the appliance facility 140 to embedded endpoint computer security facilities, may include a set of tools that may be the same or different for various implementations, and may allow each network administrator to implement custom controls. In embodiments, these controls may include both automatic actions and managed actions. The administration facility 134 may configure policy rules that determine interactions. The administration facility 134 may also establish license management, which in turn may further determine interactions associated with licensed applications. In embodiments, interactions between the threat management facility 100 and the network 102 may provide threat protection to the network 102 by managing the flow of network data into and out of the network 102 through automatic actions that may be configured by the threat management facility 100 for example by action or configuration of the administration facility 134.

Client facilities 144 within the network 102 may be connected to the network 102 by way of wired network facilities 148A or wireless network facilities 148B. Mobile wireless facility clients 144, because of their ability to connect to a wireless network access point, may connect to the Internet 154 outside the physical boundary of the network 102, and therefore outside the threat-protected environment of the network 102. Such a client 144, if not for the presence of a locally installed endpoint computer security facility 152, may be exposed to a malware attack or perform actions counter to network 102 policies. Thus, the endpoint computer security facility 152 may provide local protection against various threats and policy violations. The threat management facility 100 may also or instead be configured to protect the out-of-enterprise facility 102 mobile client facility (e.g., the clients 144) through interactions over the Internet 154 (or other network) with the locally installed endpoint computer security facility 152. Thus, mobile client facilities that are components of the network 102 but temporarily outside connectivity with the network 102 may be provided with the threat protection and policy control the same as or similar to client facilities 144 inside the network 102. In addition, mobile client facilities 144 may receive the same interactions to and from the threat management facility 100 as client facilities 144 inside the enterprise facility 102, such as by receiving the same or equivalent services via an embedded endpoint computer security facility 152.

Interactions between the threat management facility 100 and the components of the network 102, including mobile client facility extensions of the network 102, may ultimately be connected through the Internet 154 or any other network or combination of networks. Security-related or policy-related downloads and upgrades to the network 102 may be passed from the threat management facility 100 through to components of the network 102 equipped with the endpoint computer security facility 152. In turn, the endpoint computer security facility 152 components of the enterprise facility or network 102 may upload policy and access requests back across the Internet 154 and through to the threat management facility 100. The Internet 154 however, is also the path through which threats may be transmitted from their source, and an endpoint computer security facility 152 may be configured to protect a device outside the network 102 through locally deployed protective measures and through suitable interactions with the threat management facility 100.

Thus, if the mobile client facility were to attempt to connect into an unprotected connection point, such as at a secondary location 108 that is not a part of the network 102, the mobile client facility 144 may be required to request network interactions through the threat management facility 100, where contacting the threat management facility 100 may be performed prior to any other network action. In embodiments, the client facility's 144 endpoint computer security facility 152 may manage actions in unprotected network environments such as when the client facility (e.g., client 144F) is in a secondary location 108, where the endpoint computer security facility 152 may dictate what applications, actions, resources, users, etc. are allowed, blocked, modified, or the like.

The secondary location 108 may have no endpoint computer security facilities 152 as a part of its components, such as its firewalls 138B, servers 142B, clients 144G, hubs and routers 148C-D, and the like. As a result, the components of the secondary location 108 may be open to threat attacks, and become potential sources of threats, as well as any mobile enterprise facility clients 144B-F that may be connected to the secondary location's 108 network. In this instance, these components may now unknowingly spread a threat to others connected to the network 102.

Some threats do not come directly from the internet 154. For example, a physical proximity threat 110 may be deployed on a client device while that device is connected to an unprotected network connection outside the enterprise facility 102, and when the device is subsequently connected to a client 144 on the network 102, the device can deploy the malware or otherwise pose a threat. In embodiments, the endpoint computer security facility 152 may protect the network 102 against these types of physical proximity threats 110, for instance, through scanning any device prior to allowing data transfers, through security validation certificates, through establishing a safe zone within the network 102 to receive data for evaluation, and the like.

Having provided an overall context for threat detection, the description now turns to a brief discussion of embodiments of the present concept, followed by a description of systems and methods for active threat response including host or endpoint isolation.

Advantageously, firewall systems herein may be configured to filter the data received in order to reduce the overall consumption of processing resources required by the firewall system such that only specific metadata is sent to the remote and/or cloud-based ML model and/or system for processing and analysis.

Therefore, an initial metadata filtering procedure may be implemented locally by the firewall system in order to determine whether a known policy exists for specific portions of received network traffic. This may separate and/or filter the metadata such that only portions of the metadata associated with the network traffic are prepared and provided for remote ML processing. Other portions which do not require remote ML processing do not have prepared and provided metadata. This may reduce the processing power required at the firewall system level but still enable real time processing of network traffic for threats. Thus, in various contemplated embodiments, only metadata associated with network traffic that is not already known in a localized IoC database may be provided to the remote and/or cloud-based ML model and/or system for processing and analysis.

Still further, packet analysis systems located on the firewall system contemplated herein may be configured to prepare flow metadata associated with any portions of network traffic which require ML analysis. This preparation of flow metadata may be provided in real time using an inline process. In other words, all the network traffic received may be reviewed for metadata filtering and extraction. The ML system (e.g., a remote and/or cloud-based ML algorithms) may process network traffic while the network traffic is being locally processed with IoC threat based processing, which may occur simultaneous to the ML NDR processing. The firewall system may receive a real time response from the ML system based on this remote ML analysis and apply this result to the current IoC processing of the network traffic by taking action on the network traffic in accordance with any updated threat information provided by the ML system.

In further various embodiments, a fast path system may be utilized in the firewall system in order to accelerate the network traffic.

Applications of the embodiments described in the present disclosure improve the functionality of firewall systems by being able to perform real time ML analysis on network traffic while the same network traffic is being reviewed by a firewall system based on known IoCs and threats. Further, embodiments described herein advantageously incorporate a fastpath system directly into the firewall for processing network traffic inline for metadata extraction and filtering. Advantageously, embodiments of the firewall systems are configured to filter metadata in order to only provide metadata associated with a portion of received traffic to machine learning algorithms in order to efficiently perform machine learning analysis. Still further, advantageously, firewall systems contemplated herein are configured to receive ML analysis regarding network traffic and perform actions on the network traffic based on the ML analysis. Further advantageously, firewall systems contemplated herein are configured to receive ML analysis regarding network traffic and update local IoC databases with new information based on the ML analysis.

Applications of the embodiments described in the present disclosure improve the capabilities of network administrators, and more particularly firewall administrators by enabling firewall administrators to enable or disable NDR and/or ML processing of network traffic, select interfaces on which the traffic analysis should occur, define traffic verdicts based (e.g., “log only” or “log and drop”) on IoCs detected by the ML systems, define minimum IoC threat scores for which the traffic verdict is expected, add domain and/or IP addresses as threat exception for the purposes of ML analysis to prevent unnecessary processing and/or blocks and false positives, have visibility in a control center interface for a number of flows blocked and an NDR status, have visibility on the actions taken on the traffic flows based on the NDR IoCs, view the number of flows sent to the ML system for analysis, and view the number of IoCs of different threat scores.

Applications of the embodiments described in the present disclosure improve the capabilities of remote ML algorithmic processing of data by enabling efficient and inline remote processing of network traffic in a firewall by ensuring only relevant flow metadata is provided to the ML system. Thus, embodiments described herein filter out flow metadata based on a pre ML-processing threat lookup to minimize the number of metadata required for analysis.

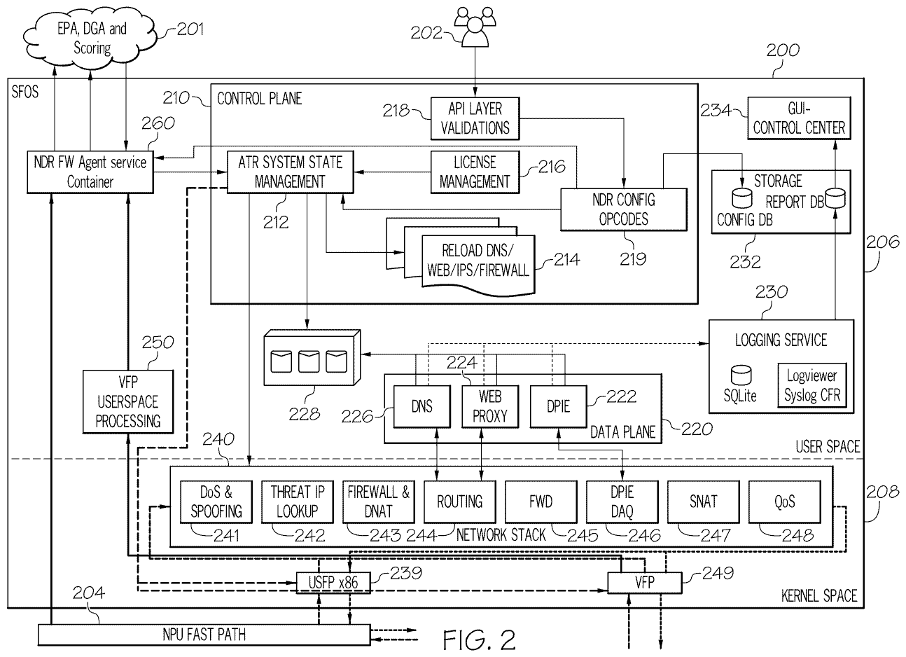

FIG. 2 depicts an architectural schematic view of a firewall system 200, according to an example embodiment. The firewall system 200 may represent any type of firewall system and may include a user space 206 and a kernel space 208. The firewall system 200 may be managed by an administrator UI system 202 operably connected to the user space 206, which may provide various options for an administrator to configure the firewall system 200, as described herein below. While not shown, the administrator UI system 202 may be an operable component of a central threat management system that is connected and/or otherwise in operable communication with the firewall system 200. The firewall system 200 is further connected to an ML system 201, which is configured to receive prepared metadata associated with network traffic processed by the firewall system 200 and return threat analysis information associated with that received metadata and/or the associated network traffic. The firewall system 200 may be in operable communication with a network processing unit (NPU) fastpath system 204.

The administrator UI system 202 may include a UI interface which may be operably connected to a control plane 210. The administrator UI system 202 may provide for remote access to the control plane 210 by firewall administrators. Workflows provided by the system described herein enable a web administrator user to use the administrator UI system 202 associated with a customer or client (e.g., a web administrator of a central threat management system, or a web administrator of a monitored customer network inclusive of the firewall system 200) to be able to perform an enable or disable command for the proposed ML methods described herein. Web administrator users may further be able to use the administrator UI system 202 to enable or disable NDR and/or ML processing of network traffic, select interfaces on which the traffic analysis should occur, define traffic verdicts based (e.g., “log only” or “log and drop”) on IoCs detected by the ML systems, define minimum IoC threat scores for which the traffic verdict is expected, add domain and/or IP addresses as threat exception for the purposes of ML analysis to prevent unnecessary processing and/or blocks and false positives, have visibility in a control center interface for a number of flows blocked and an NDR status, have visibility on the actions taken on the traffic flows based on the NDR IoCs, view the number of flows sent to the NDR ML system for analysis, and view the number of IoCs of different threat scores.

The firewall system 200 includes the user space 206 with at least two sections—1) a control plane 210 which is configured to handle the configuration and update of the proposed NDR ML system; and 2) a data plane 220 which is configured to handle IOC lookup for running traffic and apply action of “log only” or “log and drop.”

The control plane 210 includes an API layer validations module 218 operably connected to the administrator UI system 202. The API layer validations module 218 is operably connected to a backend which includes NDR configuration opcodes 219 which includes configurations related to features such as enable/disable, interface selection updates, threat score settings updates, action updates. The NDR configuration opcodes 219 are operably connected to write to a configuration database of a storage system 232.

The control plane 210 further includes an ATR system state management module 212. The ATR system state management module 212 includes a Kernel IPSet and Iptables rules handling system, shared memory, a creation and/or update and/or destroy system, an HA synchronization system, an IoC periodic cleanup system, and an interface flags system. The ATR system state management module 212 is operably connected to a license management system or module 216, which may provide license notifications to the ATR system state management module 212. The ATR system state management module 212 may further be operably connected to the NDR configuration opcodes 219 to provide the ATR system state management module 212 for update system states. The ATR system state management module 212 may further notify a reload DNS/Web/IPS/Firewall system or module 214.

The ATR system state management module 212 may further be in communication with an indicator of compromise database 228 that includes NDR IOCs populated in a shared memory space which also communicates with the data plane 220.

The data plane 220 includes a domain name system (DNS) service 226, a web proxy service 224 and a deep packet inspection engine (DPIE) service 222. Each of these services 222, 224, 226 may be configured to perform IOC lookups with the indicator of compromise database 228 associated with DNS traffic through the firewall system 200, web traffic through the firewall system 200, and DNS traffic inspected with DPIE through the firewall system 200.

The firewall system 200 may further include a logging service system 230 including an SQL database and a syslog client. This logging service system 230 may be in communication with a reporting database of the storage system 232. The reporting database of the storage system 232 may further be operably connected to a GUI control center system 234 which may include a threat detection counter system which receives information The logging service system 230 may further be in communication with the data plane 220.

In addition, the firewall system 200 includes the kernel space 208 through which traffic is input and output. The traffic is input into a network stack 240 within the kernel space 208 via either an x86 filtering platform 239 or a virtual filtering platform (VFP) 249. The network stack 240 includes several services or APIs including a denial of service (DoS) & spoofing service 241, a threat lookup service 242, a firewall and a destination network address translation (DNAT) service 243, a routing service 244, a port forwarding (FWD) service 245, a DPIE data acquisition service 246, a secure network address translation (SNAT) service 247 and a quality of service (QoS) service 248. These various services 241, 242, 243, 244, 245, 246, 247, 248 send and receive information to and from the x86 filtering platform 239 or a virtual filtering platform (VFP) 249.

The x86 filtering platform 239 may be operably connected to an NPU Fast Path system 204 to allow input and output network traffic to flow therethrough. The x86 filtering platform 239 may be a separate platform outside the firewall system 200 or may be housed within the firewall system. Whatever the embodiment, the NPU Fast Path system 204 may be operably connected to an NDR FW agent service 260, which may be a containerized service for metadata processing. Thus, the NDR FW agent service 260 may be configured for metadata retrieval, metadata filtering, metadata batching, metadata posting, IoC response retrieval, IoC processing, and timer management. The metadata filtering performed by the ANDR FW agent service 260 and/or the ML processing of the filtered metadata may be performed asynchronously with the firewall system 200 performing threat lookups in the one or more threat lookup services 242 of the firewall system 200.

The VFP 249 may be operably connected to a VFP user space metadata processing service 250 located within the user space 206 of the firewall system 200. While not shown, the NPU fast path 204 may also filter traffic into the VFP 249 in some embodiments. Likewise, the VFP user space metadata processing service 250 may also process packets from the x86 filtering platform 239 in some embodiments.

The firewall system 200 may be configured to allow an administrator to enable or disable NDR ML processing using the administrator UI system 202. To handle such a change, the firewall system 200 may be configured to validate and store configuration information in the configuration database of the storage system 232. If a valid customer license exists for NDR ML processing and the feature is enabled, then the firewall system 200 creates shared memory and IPsets. If there is an existing IoC file available, the firewall system populates the shared memory and IPset. Iptables rules may be prepared and subsystems (firewall, DNS, Web, IPS, TLS) may be notified. When the NDR ML agent service begins, interface flags may be propagated using the file system to enable any metadata processing systems, such as the VFP user space processing service 250.

If there is a valid customer license and the NDR ML processing is disabled, the interface flags may be cleared to switch off any metadata processing and/or monitoring. The NDR ML agent service, such as the ML system 201 may be disabled, and any Iptables rules may be removed. The IPSet and shared memory may be destroyed, and the various subsystems (firewall, DNS, Web, IPS, TLS) may be notified. An admin event may be generated for the new configuration.

If an administrator wishes to update an action parameter in using the administrator UI system 202, the firewall system may validate and store configuration information in the configuration database of the storage system 232. If the IoC Json file is present, its action field will be updated with the new action. Iptables will then be updated with the new rules. If there is a valid license present and the feature is enabled, and if there is at least one IoC in a “valid” state, shared memory and IPSets may be updated using the new IoC file.

If an administrator wishes to update a minimum threat score setting of the NDR ML system using the administrator UI system 202, the firewall system may validate and store configuration information in the configuration database of the storage system 232. If the IoC Json file is present, it may be parsed and updated with the new state according to a new score threshold. If there is any IoC state change from “valid” to “invalid” or vice versa, if the changed IoCs are IP addresses, these are added to an “ips to add” list or “ips to remove” list accordingly. If there is a valid license present and the feature is enabled, and if there is a requirement to update shared memory and IPSets, those will be updated using the new IoC file and ip lists.

If an administrator wishes to update the “interfaces” settings from of the NDR ML system using the administrator UI system 202, the firewall system may validate and store configuration information in the configuration database of the storage system 232. If there is a valid license present and the feature is enabled and if the service is running, the ndr flags on the interfaces may be set/cleared using the filesystem. Based on this interface flag, the metadata processing system may start/stop monitoring packets on the interface to prepare the metadata.

If an administrator performs interface configurations from the administrator UI system 202, if the interface is getting disabled, then the interface flags are cleared and the interface entry may be retained in the storage system 232. If the interface is getting enabled again, the interface flags may be set in the metadata processing system if the NDR ML service is running. If the interface zone changes to WAN, the interface flags may be cleared in the metadata processing system. Then, the interface may be removed from the storage system 232 so that this interface will no longer be displayed in the UI. If the interface is getting removed or unbinded, the interface flag may be cleared by the metadata processing system. Removal of the database entry happens using delete cascade, and so the interface will no longer be displayed.

If an administrator wishes to update a threat exclusion list, the firewall system may validate and store configuration information in the configuration database of the storage system 232. For all the domains and IPs added, if the same is existing in the IoC file, the state is changed to “exception” if it is not already. Upon changing, a reload may be needed. If the IoC is an IP address type, add the IP to “IPs to remove” list. For all the domains and Ips removed from the threat exclusions, if the same is existing in the IoC file, the state is changed to “valid” if the score is above the configured threshold, otherwise the state is changed to “invalid.” If the state was changed to “valid,” a reload may be needed. If the IoC is an IP address type, add the IP to the “IPs to add” list.

The opcode will process the file created by the NDR Agent service and will update the master json file that contains all the IoC identified to date. When an IoC is received from the cloud ML system 201, a temporary IoC Json file may be created in/tmp/ndr_tmp/. For each IoC mentioned in the temporary file (created after receiving IoC(s) from cloud ML), various actions may be performed. If the IoC already exists in the master list and if the Score is higher than or equals to the existing IoC, the threat score field will be updated with the new score and update category and timestamp of expiry. If the new score is equal or more than the minimum threat score threshold configured, and if the state is “inavalid”, the state is changed to “valid” and the requirement for eyas/ipset update is marked as TRUE. In the above case if the IoC is of ip address type, add the IP to “ips_to_add” list for IPSET update. If the Score is lesser than the existing IoC, the timestamp of expiry of IoC is updated.

If the IoC is not existing in the master list the IoC is added to the file. An Opcode will check the firewall's interface IP addresses and ensure those are never added as an IoC. If the new score is equal or more than the minimum threat score threshold configured, the IoC is evaluated against the “threat exclusion list” and if not present, the state is set as “valid” and the requirement for eyas/ipset update is marked as TRUE. Otherwise, the state is set as “exception.” If the IoC state is valid and it is of ip address type, the IP is added to “ips_to_add” list for IPSET update. If the new score is lesser than the threshold configured, the IoC is evaluated against the “threat exclusion list” and if not present, the state is set as “invalid”. Otherwise, the state is set as “exception”.

After processing the temporary IoC file, the same is removed.

The disk size used by the new file will be evaluated, and if it is above 95% of the disk quota allotted, if N new IoCs were added by these operations, N number of IoCs may be deleted from the Json file; the IoCs with lowest score and lowest timestamp for expiry.

If requirement for eyas/ipset update is set as TRUE, the eyas utility is called to reload the shared memory with latest set of IoCs and the new set of IP addresses is added to the IPSET.

In various embodiments, the user space metadata processing service 250 may run in a fastpath and may perform a deep packet inspection of each connections on selected interfaces. If the connection is of DNS or TLS, the extracted metadata may be sent to the user application (NDR Agent) in batches using the protobuf structure. For the NPU variant of the user space metadata processing service 250, the metadata will be sent over UDP socket (Port: 65015). The x86 variant of the user space metadata processing service 250 may send the metadata over a Unix Domain Socket.

The NDR FW agent service 260 may be configured to receive metadata from the user space metadata processing service 250 and do any required filtering. This may include an SXL lookup in order to prepare and send the metadata request to the cloud ML system 201, receive IoCs from the cloud ML system 201, and maintain an IoC list.

Metadata for the TLS and DNS connections inspected by the user space metadata processing service 250 may be received by the NDR FW agent service 260. The NDR FW agent service 260 runs in a container and may listen to the UDP or Unix Domain Socket depending on the platform. On the received metadata set, the NDR FW agent service 260 will perform various functions.

First, the NDR FW agent service 260 will perform Deduping. Deduping is done over the SXL lookup parameter. If “hostname” parameter is present, that will be used else “dest_ip” field may be used. Each metadata may be parsed to request metadata structure (mentioned below) and may be stored in a map of slices where the key the SXL lookup parameter and values are the metadata for each key.

Once the max number of metadata has been received or configured time period has been elapsed, the deduped metadata may be used for SXL lookup and filtering. Each unique lookup key (Domain/IP) may be queried with nSXLd service over the Unix Domain Socket for the category. If the returned category is one of “Uncategorized”, “None”, “Command/Control” and “Spyware/Malware”(optional), the metadata may be selected for ML analysis and all others will be dropped from further processing. These limits (maximum number and wait time) may be set after performance testing for each model.

The filtered metadata may be further batched for a max size of 1000 metadata or a period of 60 seconds, for example. Post that, the selected metadata payload may be compressed using gzip. After this the request will be sent to the NDR ML service 201 running outside the firewall system 200.

The response retrieval from the NDR ML service 201 may include one or more APIs, such as a GET API used to retrieve completed report IDs, and a GET API used to retrieve the IoC result for a specific report ID.

While processing a response, domain and IP address validations may be performed for each IoC. Once the IoCs are received from the NDR ML service 201, the NDR FW agent service 260 may buffer up to 5 minutes or up to 100 IoCs (for example, whichever is earlier), although this buffering time or number of IoCs may be changed. Once buffering is completed, the service will create the temporary file containing the received IoC data and invoke the opcode for updating the IoC Json file.

The NDR FW agent service 260 may further periodically write to a file the analysis status (number of flows metadata sent to the NDR ML service 201, number of IoCs received including at each score. The administrator UI system 202 may display this information.

Various control parameters may be populated during the service initialization, including: number of worker routines to process the receive buffers after socket read for metadata processing; max number of receive buffers that can be allocated for metadata fetching; max number of metadata that will be deduped in a batch for performing the SXL lookup based filtering; max number of send buffers to retain the metadata in the firewall for which the batches of metadata failed to be send to cloud ML; max batch size for each request; max batching period for each request. These may act as control parameters to ensure the resource utilization of the NDR FW agent service 260 are kept optimal.

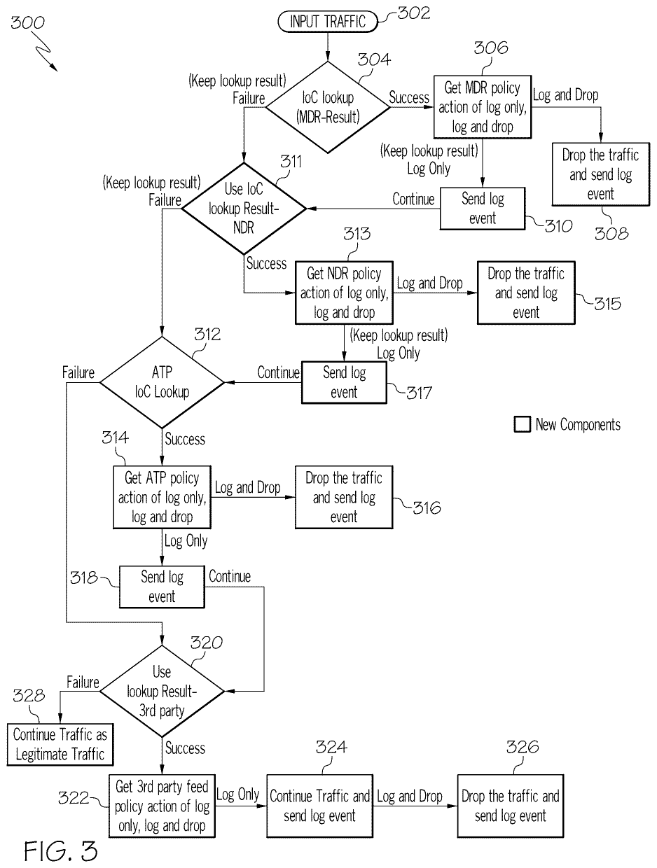

FIG. 3 depicts a flow chart for performing a lookup by a consumer, according to an example embodiment. The lookups may be performed using the one or more threat lookup services 242 of the firewall system 200, as shown in FIG. 2. Furthermore, the performing the various threat lookups described herein may be performed on the network traffic asynchronously with the analysis by the remote machine learning model after being provided the extracting the filtered metadata. Thus, the flow chart shown in FIG. 3 may include IoC threat lookups from various sources which may be occurring locally by the firewall system during and after the firewall system processes the network traffic inline and prepares the metadata needed by the NDR ML service 201. For example, after this inline network traffic processing and metadata preparation, the network traffic may proceed through various threat feed lookups described herein.

The flow chart 300 includes a first step 302 whereby traffic is input into a firewall system. At step 304, an IOC lookup is conducted for MDR-input IOCs provided by an MDR system. If this IOC lookup is successful, a step 306 includes getting an MDR policy action of “log only” or “log and drop.” If the policy action is “log and drop”, a step 308 of dropping the traffic and sending a log event. In this event, If the policy is to log only, a step 310 includes sending a log event. Thus, the steps 304, 306, 308, 310 include separating, by the firewall, a portion of the network traffic for dropping if an initial policy lookup is successful and the MDR policy is to log and drop.

If the IOC lookup fails or if the policy is log only, the flow chart 300 includes a step 311 of performing an NDR IOC lookup using a ML system in accordance with embodiments described herein. If the lookup succeeds, a step 313 includes getting an NDR policy action of log only or log and drop. This NDR policy action may be obtained by receiving information from a ML system and using that information by a firewall system to implement rules resulting in an action of log only or log and drop. Thus, the NDR policy agent according to steps 311, 313 may include preparing, by the firewall, the portion of the network traffic that has been separated by the steps 304, 306, 308, 310 (i.e. the portion not dropped in step 308) or metadata associated with the portion of the network traffic for analysis by generating flow metadata associated with the portion of the network traffic. If the instruction based on the NDR policy action is to log and drop, a step 315 includes dropping the traffic and sending a log event to a logging system or database. If the instruction based on the NDR policy action is to log only, a step 317 includes sending a log to the logging system or database.

If the NDR IOC lookup fails or if the policy is to log only, the flow chart 300 includes a step 312 of performing an advanced threat protection (ATP) IOC lookup from a threat feed database or threat feed providers (such as a URL provided by Sophos X-Ops). If this ATP lookup is successful, a step 314 includes getting an ATP policy action of “log only” or “log and drop.” If the policy action is “log and drop”, a step 316 of dropping the traffic and sending a log event. If the policy is to log only, a step 318 includes sending a log event.

If the ATP lookup fails or if the policy is to log only, the flow chart 300 includes a step 320 of performing a third-party IOC lookup. If this third-party lookup is successful, a step 322 includes getting a third party policy action of “log only” or “log and drop.” If the policy action is “log only”, a step 324 of includes sending the log event and continuing the traffic. If the policy is to log and drop, a step 326 includes a step of dropping the traffic and sending the log event. If the third-party IOC lookup fails, the traffic is continued as legitimate traffic at a step 328.

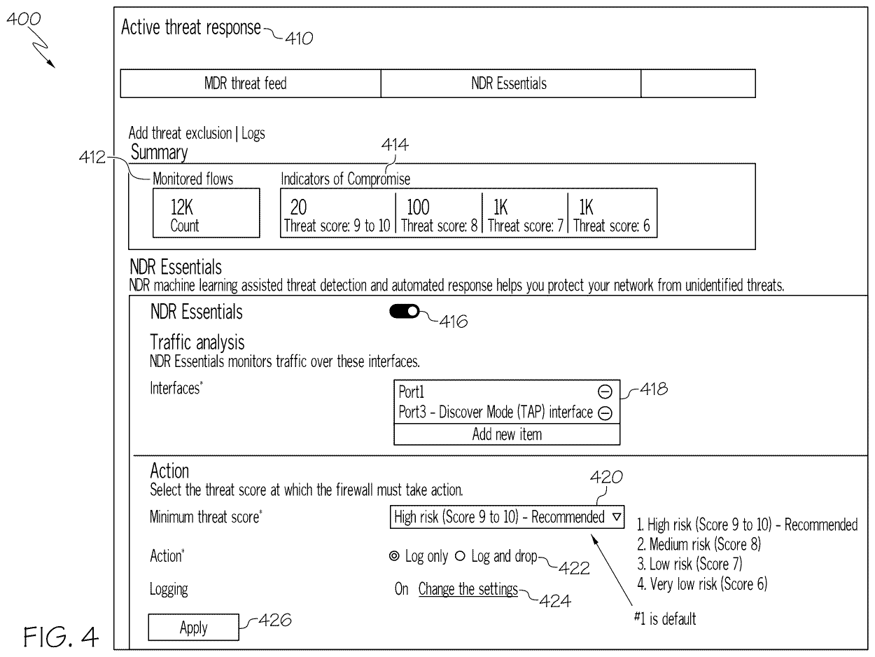

FIG. 4 depicts a user interface 400 for a firewall system, according to an example embodiment. The user interface 400 may be a screenshot or interface embodying the administrator UI system 202 shown in FIG. 2. The user interface 400 includes an active threat response service selection interface 410. As shown, the service selection interface 410 includes the NDR ML service selected. The UI located below the service selection interface 410 corresponds to this selection. Thus, the NDR ML service page is currently being viewed pursuant to the selection at the service selection interface 410.

The NDR ML service page includes a summary of monitored flows 412 and indicators of compromise (IoCs) 414. As shown, the summary shows that twelve thousand flows have been monitored by the NDR ML service. Out of those flows monitored, 20 IoCs having a threat score of 9 or 10 were found, 100 IoCs having a threat score of 8 were found, about one thousand IoCs having a threat score of 7 were found, and about one thousand IoCs having a threat score of 6 were found.

The user interface 400 includes an on/off toggle 416 for turning on or off the NDR ML service in the firewall system. The user interface 400 further includes an interface toggle 418 which allows an administrator to pick ports subject to the operation of the NDR ML service. Still further, the user interface 400 includes an action display including a minimum threat score toggle 420, an action toggle 422, and a logging toggle 424. These toggles 420, 422, 424 may be set by an administrator in order to set the actions taken by the NDR ML service on network traffic. As shown, any threat scores of 9 or 10 returned by the NDR ML service will be logged only. Logging is currently on. In other embodiments in which log and drop is toggled on the action toggle 422, logging may be turned off with the logging toggle 424. An apply button 426 is included, which may apply any changes within the NDR ML service made by the administrator.

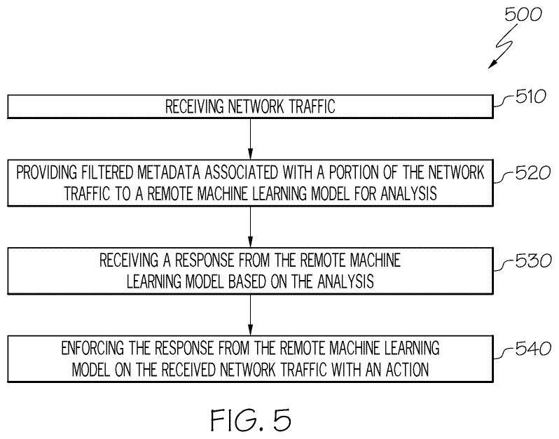

FIG. 5 depicts a flow chart for a method 500 for responding to a threat, according to an example embodiment. The method 500 includes a step 510 of receiving, by for example a firewall or firewall system (such as the firewall 200 of FIG. 2) of a monitored network system, network traffic. The method 500 includes a step 520 of providing, by the firewall or firewall system, filtered metadata associated with at least a portion of the network traffic to a remote machine learning model for analysis, such as the ML system 201. The method 500 still further includes a step 530 of receiving, by the firewall or firewall system, a response from the remote machine learning model based on the analysis. The response may include a threat score, for example. Alternatively, the response may be associated with an indicator of compromise (IoC). The method 500 may further include a step 540 of enforcing the response from the remote machine learning model on the received network traffic with an action. Thus, upon receiving the response, the method 500 may include the firewall of firewall system taking action upon the received network traffic based on the response, and/or save information about the network traffic, or an indicator of compromise associated with the network traffic, based on the response.

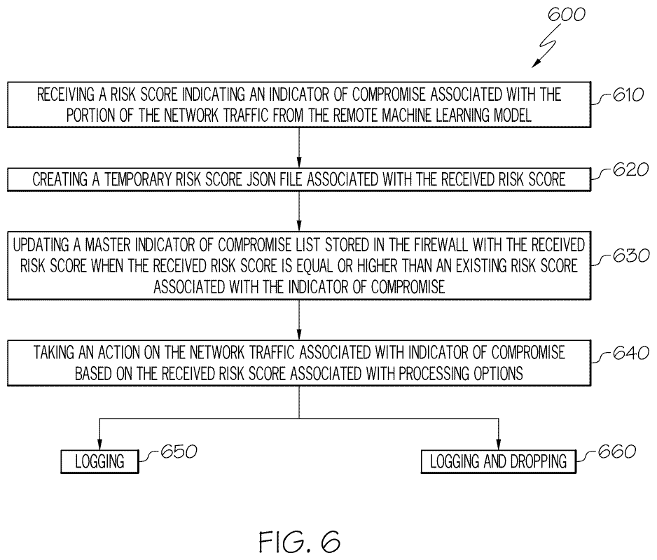

FIG. 6 depicts a flow chart for a method 600 of responding to a ML model analysis of network traffic, according to an example embodiment. Any of the steps (e.g., one or more of the steps) presented in the method 600 may be taken, for example, after the steps in the method 500 described hereinabove. Thus, the method 600 may include a step 600 of receiving a risk or threat score, by the firewall or firewall system from the ML system, indicating an indicator of compromise associated with the portion of the network traffic from the remote machine learning model. The method 600 may further include a step 620 of creating, by the firewall or firewall system, a temporary risk score Json file associated with the received risk score and/or saving this Json file locally on the firewall. The method 600 may further include a step 630 of updating, by a firewall or firewall system, a master indicator of compromise list stored in the firewall with the received risk score when the received risk score is equal or higher than an existing risk score associated with the indicator of compromise. While not shown, the method 600 may further include a step of cleaning, by the firewall with a time to live (TTL) based cleanup mechanism, a master indicator of compromise list after receiving the risk score from the remote machine learning model. This step may include adding, by the firewall or firewall system, the received risk score associated with the portion of the network traffic to the master list stored in the firewall when the indicator of compromise is not found on the master list. The method 600 may further include a step 640 of taking an action, by the firewall or firewall system, on the portion of the network traffic associated with the filtered metadata based on the received risk score associated with processing options. This taking of action may, for example, include at least one of a step 650 of logging and/or a step 660 of logging and dropping the portion of the network traffic.

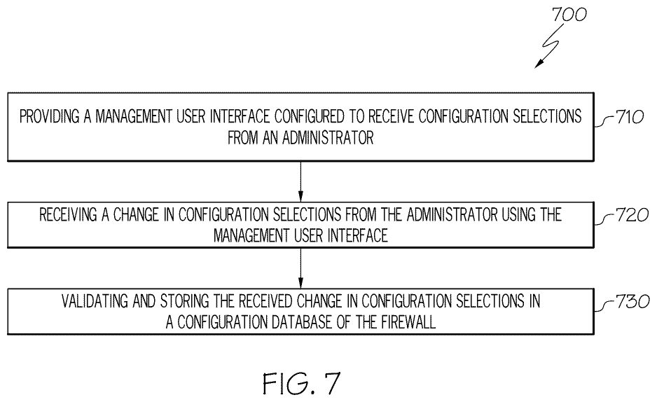

FIG. 7 depicts a flow chart for a method 700 of interfacing with a firewall system connected to a ML model, according to an example embodiment. The method 700 may include various steps which may be taken by an administrator using an administrator UI such as the UI 202 of FIG. 2 and/or the UI 400 of FIG. 4. The method 700 includes a step 710 of providing a management user interface (such as the interface 202 and/or 400) configured to receive configuration selections from an administrator. The configuration selections may be related to associating the received risk scores from the remote machine learning model with the taking the action, such as the various toggles 420, 422, 424. The method 700 may include a step 720 of receiving, by the firewall, a change in configuration selections from the administrator using the management user interface and a step 730 of validating and storing the received change in configuration selections in a configuration database in the firewall or firewall system.

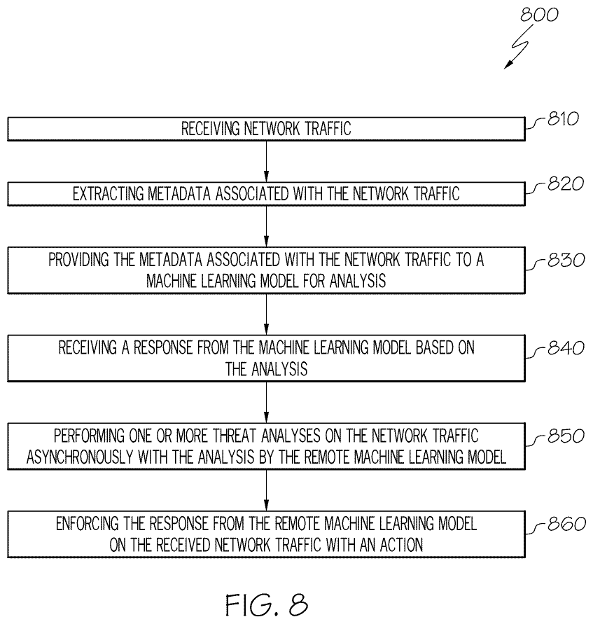

FIG. 8 depicts a flow chart for a method 800 for responding to a threat, according to an example embodiment. The method 800 includes a step 810 of receiving, by for example a firewall or firewall system (such as the firewall 200 of FIG. 2) of a monitored network system, network traffic. The method 800 includes a step 820 of extracting, by the firewall or firewall system, metadata (e.g., flow metadata) associated with the network traffic or a portion of the network traffic. The method may include a step 830 of providing, by the firewall or firewall system, the metadata associated with the network traffic to a remote machine learning model for analysis, such as the ML system 201. The method 800 still further includes a step 840 of receiving, by the firewall or firewall system, a response from the remote machine learning model based on the analysis. The response may include a threat score, for example. Alternatively, the response may be associated with an indicator of compromise (IoC). The method 800 may further include a step 850 of performing, by the firewall or firewall system, one or more threat analyses, such as the analyses shown in FIG. 3, on the network traffic asynchronously to the processing and/or analysis by the machine learning model. The method 800 may include a step 860 of enforcing, by the firewall or firewall system, the response from the remote machine learning model on the received network traffic with an action. Upon receiving the response, the method 500 may include the firewall of firewall system taking action upon the received network traffic based on the response, and/or save information about the network traffic, or an indicator of compromise associated with the network traffic, based on the response. For example, any steps described herein above and shown in FIG. 6 may be taken by the firewall or firewall system in response to receiving the response from the ML system.

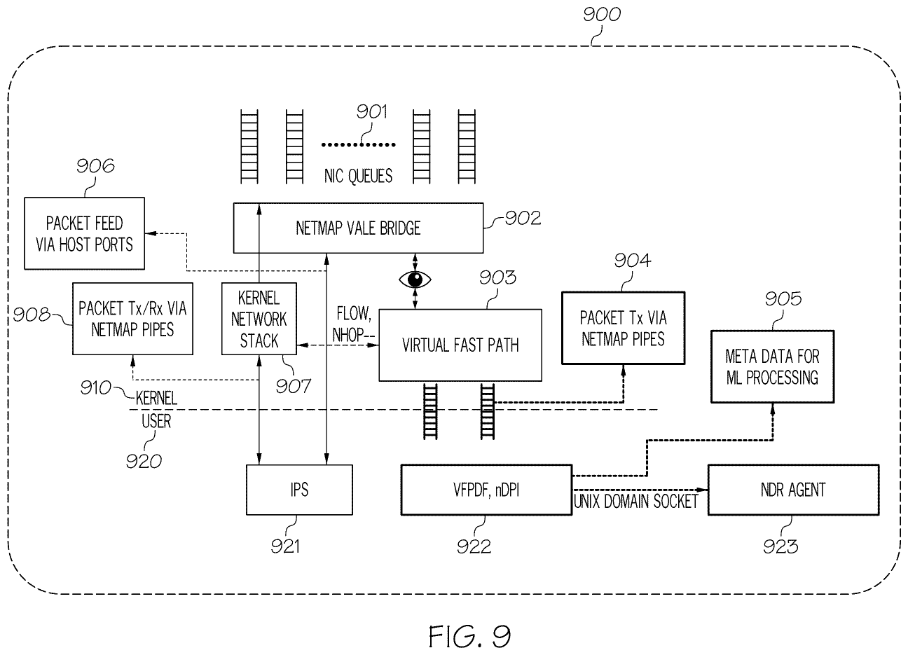

FIG. 9 depicts an architectural schematic view of a packet processing system 900 of a firewall system, according to an example embodiment. The packet processing system 900 includes a kernel space 910 and a user space 920. The kernel space 910 includes network interface card (NIC) Queues 901 which are operably connected to a netmap vale bridge 902. The netmap vale bridge 902 is operably connected to a kernel network stack 907 such as the network stack 240 shown in FIG. 2. The netmap vale bridge 902 and the kernel network stack 907 are operably connected to an intrusion prevention system 921 which may include any or all of the software systems shown in the user space 206 of FIG. 2. In particular, the netmap vale bridge 902 may be connected to the intrusion prevention system 921 with a packet feed via host ports 906. Moreover, the kernel network stack 907 may be connected to the intrusion prevention system 921 with a packet transmit and receive system via netmap pipes 908.

The packet processing system 900 further is shown including a user space metadata processing system 922, which may be the same or similar to the processing systems 250, 260 of FIG. 2. As shown in the embodiment of FIG. 9, unlike FIG. 2, a fast path system 903 (similar in function to the NPU fast path 204) is shown within the kernel space 910 of the firewall system, and may be connected to the user space metadata processing system 922. Packets may be transmitted between the fast path system 903 and the user space metadata processing system 922 via netmap pipes 904. Metadata for ML processing 905 may be output by the user space metadata processing system 922 to a ML NDR system or agent 923, which may be the same as or similar to the ML system 201 of FIG. 2.

Thus, the packet processing system 900 may be integrated with the virtual fast path system 903. Each virtual fast path system 903 may include NPU memory tuned (where applicable) to facilitate additional memory for metadata processing. A comprehensive set of counters to be made available via sysfs on x86 via usfp-firewall linux kernel module. Flow metadata in the form of google protobufs may be transmitted to x86 via virtual netdev over UDP. Per-port control for enabling/disabling dragonfly processing may further be ensured.

The packet processing system 900 may be implemented as a library with a packet injection, periodic processing, flow export, memory management, counters and logging. Packet injection may be run to complete packet handling. For periodic processing, flow table entry timeouts may triggered by a periodic call; this may be made with low millisecond period. For flow export, callback interface for populating flow metadata in buffers and transmission of flow metadata is handled by the library user; metadata format may be described by networkflow. proto. For memory management, memory pool callbacks may be included for allocating flow table entries, DPI flow entries, various DPI buffer. Likewise, memory callbacks for allocating and freeing heap memory may be included. The flow table entries include an arena buffer that is used for the majority of allocations, but some large allocations, such as large URLs, may be allocated from the heap.

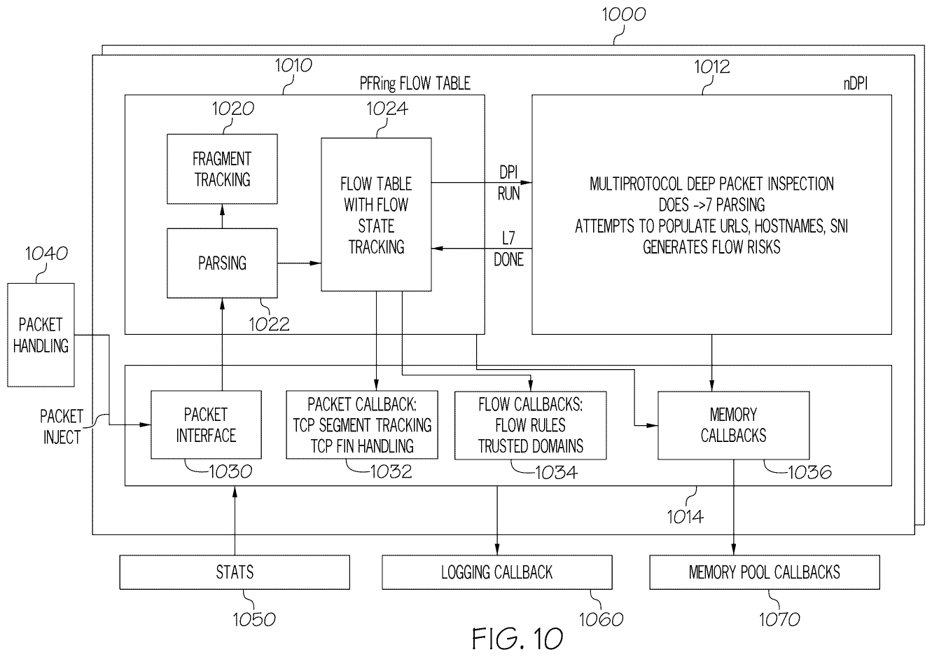

FIG. 10 depicts an architectural schematic view of instances of a metadata processing system 1000 of a firewall system, according to an example embodiment. The metadata processing system 1000 may represent subsystems within the user space metadata processing system 922 and/or the VFP user space processing system 250, described herein above.

As shown, the metadata processing system 1000 may include a plurality of instances. Each instance may include a flow table system 1010, a packet inspection system 1012, and metadata processing logic systems 1014. A packet handling system 1040 injects packets into a packet interface 1030 of the metadata processing logic system 1014. The packet interface 1030 provides packets and/or information associated with the packets to a parsing subsystem 1022 of the flow table system 1010, which communicates with a fragment tracking system 1020 and a flow table with flow state tracking system 1024.

The flow table with flow state tracking system 1024 populates a flow table using deep packet inspection and Layer 7 parsing, using the packet inspection system 1012. The flow table with flow state tracking system 1024 further operably communicates with the metadata processing logic systems 1014, and particularly a packet callback logic system 1032 for TCP segment tracking and FCP FIN handling, and a flow callback logic system 1034 for flow rules and trusted domains.

As shown, both the flow table system 1010 and the packet inspection system 1012 may be in operable communication with memory callback logic 1036 of the metadata processing logic systems 1014. The metadata processing logic system 1014 further communicates with outside-instance system to obtain stats 1050, logging callbacks 1060, and memory pool callbacks 1070.

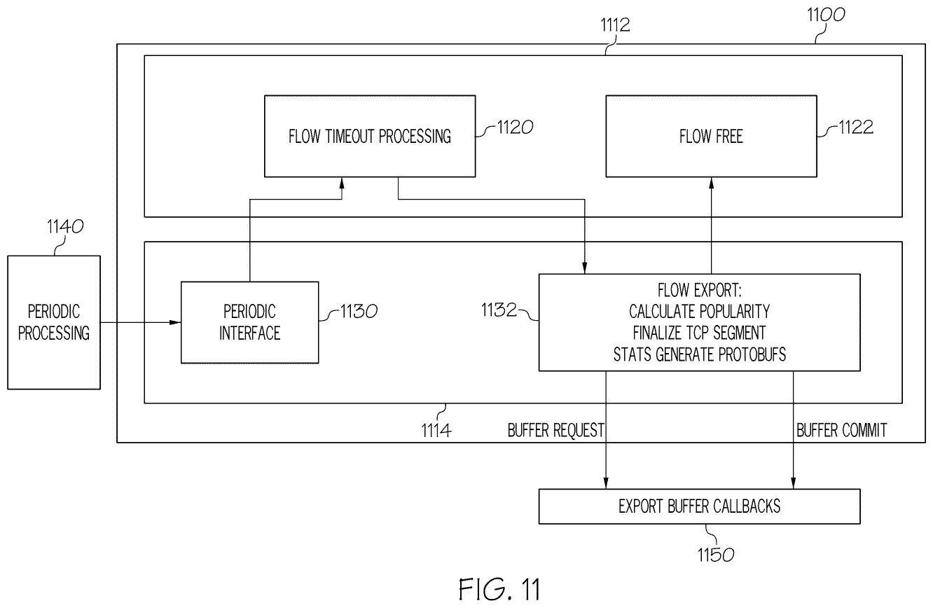

FIG. 11 depicts another architectural schematic view of a periodic metadata processing system 1100 of a firewall system, according to an example embodiment. Regarding periodic processing, flow table entry timeouts may be triggered by a periodic call. This may be made with a low millisecond period. The periodic metadata processing system 1100 receives a periodic call 1140 with a periodic interface 1130 of a logic system 1114. The periodic interface 1130 communicates with a flow timeout processing system 1120 of a flow table system 1112. The flow timeout processing system 1120 operably communicates with a flow export logic 1132 operably connected to a flow free system 1122 to calculate popularity, finalize TCP segment stats and generate protobufs. The flow export logic 1132 communicates to provide export buffer callbacks 1150 for buffer request and buffer commit.

The metadata processing systems described herein produce a number of metadata fields for export. For example, metadata fields may include the first 32 TCP segment lengths of the connection for EPA ML processing (segment determined by bytes between PSH/FIN/RST); the hostname for various protocols for DGA ML processing; cluster hash (similar to community hash, without source information) for associating flows; DPI extracted strings: url, ciphers, versions etc.; DPI calculated flow risk flags; a calculated popularity flag; flow durations, packet/bytes counts, timestamp, etc.; flow information: src/dst IP and port, protocol information, and the like.

In some embodiments, there may be no concurrency supported. In such embodiments, care may be made to make sure calls are made with mutual exclusion in place. Multiple instances may be created to allow concurrent processing for unrelated flows. In this case any given bidirectional flow, e.g a TCP connection, may be processed within the same instance.

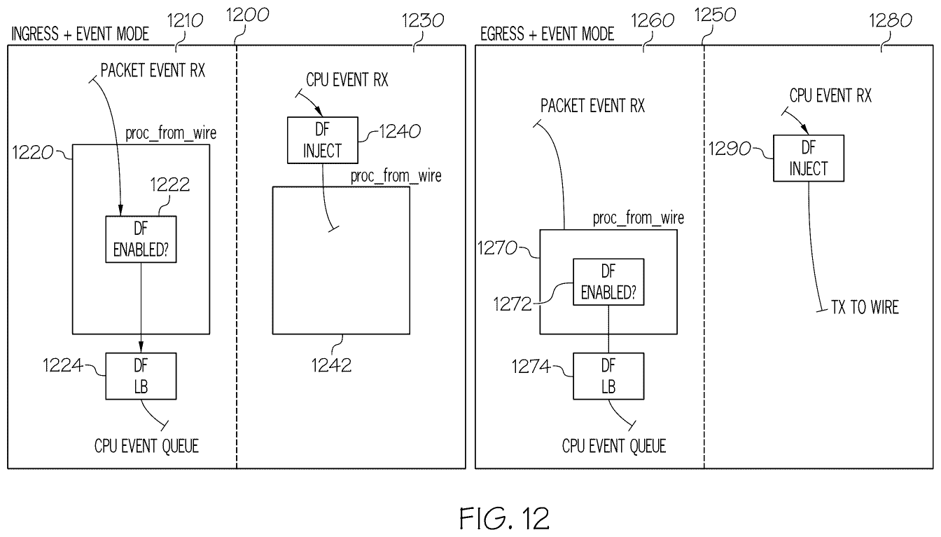

FIG. 12 depicts an ingress and egress process in event mode for a firewall system, according to an example embodiment. In the case of event mode, to achieve concurrency of the metadata processing system, the event context is converted from the default ORDERED, to a targeted ATOMIC context for every operation. The event queue may be the same for all metadata processing system events, and the flowID may match the desired instance/thread number. One instance/thread may be instantiated per packet processing core available. During the event circulation the flowID is calculated based on a symmetrical Layer 3 hash. Periodic work may be executed within periodically generated events for each instances.

As shown, an ingress process 1200 in event mode includes a packet event received 1210 by a procedural wire function 1220, which determines whether the metadata processing system is enabled 1222. If yes, the packet proceeds to the metadata processing system CPU event queue 1224. When the CPU event is received 1230 an inject system 1240 injects the packet to a procedural wire function 1242.

Furthermore, an egress process 1250 in event mode is shown including a packet event received 1260 by a procedural wire function 1270, which determines whether the metadata processing system is enabled 1272. If yes, the packet proceeds to the metadata processing system CPU event queue 1274. When the CPU event is received 1280 an inject system 1290 injects the packet to WIRE.

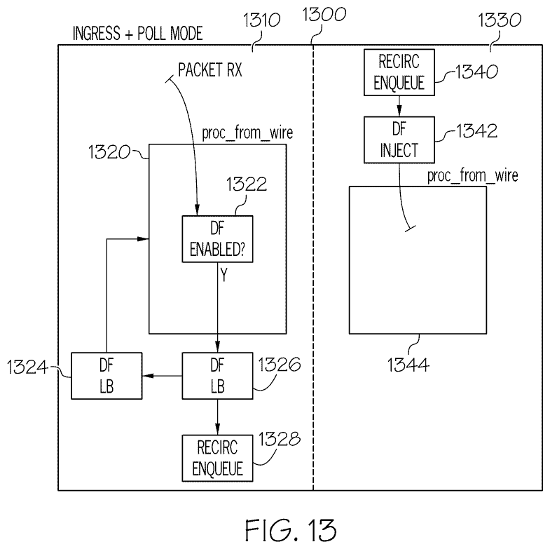

FIG. 13 depicts an ingress process in poll mode for a firewall system, according to an example embodiment. In the case of poll mode, one packet core may be mapped to one metadata packet processing instance. To achieve the mutual exclusion, metadata packet processing destined packets are directed to the desired core through an additional polled queue. Should the metadata packet processing system core not match the current core, the packet is enqueued for the other core to process it. Periodic work is executed on the mapped core.

As shown, an ingress process 1300 in a poll mode is shown including a packet event received 1310 by a procedural wire function 1320, which determines whether the metadata processing system is enabled 1322. If yes, the packet proceeds to the metadata processing system 1326 where it is either injected by the inject system 1324 or enqueued to another core for processing 1328. A dequeue process 1330 is also shown in which a dequeue 1340 is injected 1342 back into a procedural wire function 1344.

A critical consideration is how memory is handled. The per-flow memory may be drawn out of pre-allocated memory pools, sized per platform according to the amount of available memory and the desired max concurrent connection/connection rate. Each platform may need to have sufficient NPU memory set aside for this purpose. For some platforms the number of fastpath connection/flows may be reduced to accommodate a suitable amount of memory for metadata processing.

The flow exports will populate dpdk mbufs drawn from the “misc” pool. The flows may be combined into jumbo UDP datagrams and sent to the x86 system (e.g., x86 system 239) via the existing cmsg netdev. These messages can then be received as on a regular UDP socket on the host. The IPs may be link local, so forwarding may not be possible. The UDP packets may contain a sequence number to identify drops, the only source of which may be due to the UDP RX buffer filling. A large RX socket buffer size may be used to avoid flow drops.

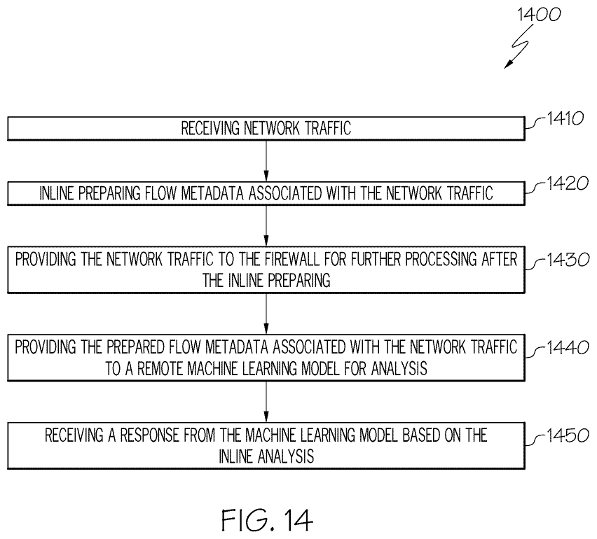

FIG. 14 depicts a flow chart for a method 1400 for responding to a threat, according to an example embodiment. The method 1400 includes a step 1410 of receiving, by for example a firewall or firewall system (such as the firewall 200 of FIG. 2) of a monitored network system, network traffic. The method 1400 may include a step 1420 of inline preparing, by the firewall or firewall system, flow metadata associated with the network traffic. The method 1400 may further include a step 1430 of providing, by the firewall or firewall system, the prepared flow metadata associated with the network traffic to a remote machine learning model for analysis (e.g., in real time), and a step 1440 of providing the prepared flow metadata associated with the network traffic to a remote machine learning model for analysis. The method 1400 may further include a step 1450 of receiving, by the firewall or firewall system, a real time response from the machine learning model based on the analysis. The real time response may include a threat score, for example. Alternatively, the real time response may be associated with an indicator of compromise (IoC). Upon receiving the response, the method 1400 may include the firewall of firewall system taking action upon the received network traffic based on the response, and/or save information about the network traffic, or an indicator of compromise associated with the network traffic, based on the response. The method 1400 may further be supplemented by any response contemplated, for example, in FIG. 6 and the various steps 610 640.

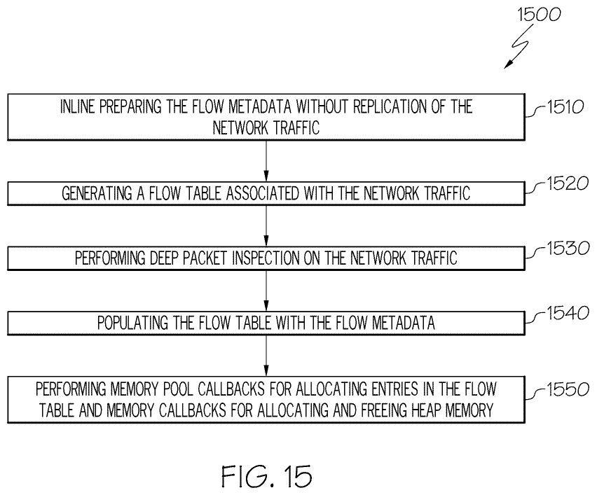

FIG. 15 depicts a flow chart for a method 1500 of preparing flow metadata for ML analysis, according to an example embodiment. The method 1500 includes a step 1510 of inline preparing, by a firewall or firewall system, the flow metadata without replication of the network traffic. In some embodiments, the various steps 1520-1550 may all be considered sub-steps of the step 1510 of preparing the flow metadata. Further, in various embodiments, the preparing may take place without the replication of network traffic. The method 1500 includes a step 1520 of generating, by the firewall or firewall system, generating a flow table associated with the network traffic. The method 1500 includes a step 1530 of performing, by the firewall or firewall system, deep packet inspection on the network traffic. The method 1500 further includes a step 1540 of populating, by the firewall or firewall system, the flow table with the flow metadata. Furthermore, the method 1500 includes a step 1550 of performing, by the firewall or firewall system, memory pool callbacks for allocating entries in the flow table and memory callbacks for allocating and freeing heap memory.

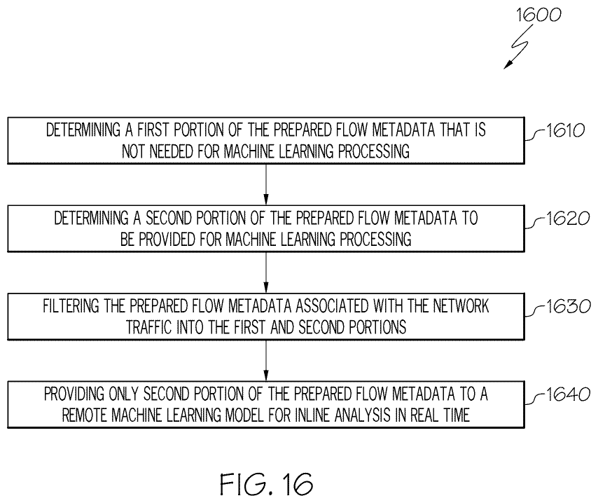

FIG. 16 depicts a flow chart for a filtering process 1600 for filtering prepared flow metadata for ML analysis, according to an example embodiment. As described above, this filtering may be performed inline in the firewall or firewall system after which network traffic may be processed with one or more threat analyses while the metadata prepared is provided to a remote and/or cloud machine learning system for asynchronous analysis. The method 1600 includes a step 1610 of determining, by a threat intelligence filter of a firewall or firewall system, a first portion of the prepared flow metadata that is not needed for machine learning processing, and a step 1620 of determining, by the threat intelligence filter of the firewall or firewall system, a second portion of the prepared flow metadata to be provided for machine learning processing. The method 1600 includes a step 1630 of filtering, by a threat intelligence filter, the prepared flow metadata associated with the network traffic into the first and second portions. The method 1600 further includes a step 1640 of providing, by the firewall, only the second portion of the prepared flow metadata to a remote machine learning model for analysis in real time.

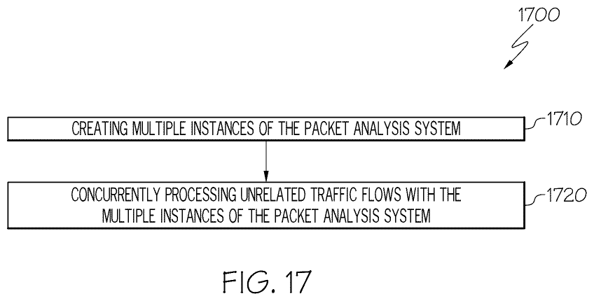

FIG. 17 depicts a flow chart for a method 1700 of creating multiple instances of a packet analysis system of a firewall system, according to an example embodiment. The method 1700 includes a step 1710 of creating, by a firewall or firewall system, multiple instances of the packet analysis system to allow concurrent processing for unrelated traffic flows. The method 1720 further includes concurrently processing, by the firewall or firewall system, unrelated traffic flows with the multiple instances of the packet analysis system.

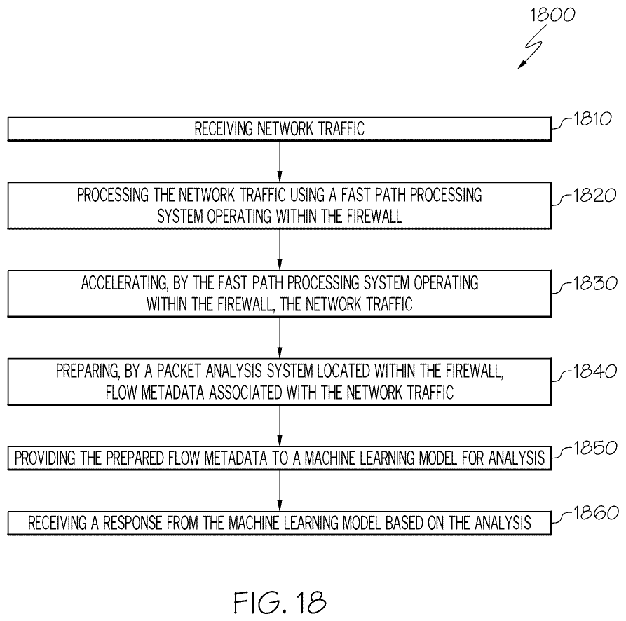

FIG. 18 depicts a flow chart for a method 1800 for responding to a threat, according to an example embodiment. The method 1800 includes a step 1810 of receiving, by a firewall or firewall system of a monitored network system, network traffic. The method 1800 includes a step 1820 of processing, by the firewall or firewall system, the network traffic using a fast path processing system operating within the firewall. The method 1800 further includes a step 1830 of accelerating, by the fast path processing system operating within the firewall or firewall system, the network traffic. The method 1800 further includes a step 1840 of preparing, by a packet analysis system located within the firewall or firewall system, flow metadata associated with the network traffic. The method 1800 further includes a step 1850 of providing, by the firewall or firewall system, the prepared flow metadata to a machine learning model for analysis. The method 1800 further includes a step 1860 of receiving, by the firewall or firewall system, a response from the machine learning model based on the analysis. The real time response may include a threat score, for example. Alternatively, the real time response may be associated with an indicator of compromise (IoC). Upon receiving the response, the method 1800 may include the firewall of firewall system taking action upon the received network traffic based on the response, and/or save information about the network traffic, or an indicator of compromise associated with the network traffic, based on the response. The method 1800 may further be supplemented by any response contemplated, for example, in FIG. 6 and the various steps 610-640.

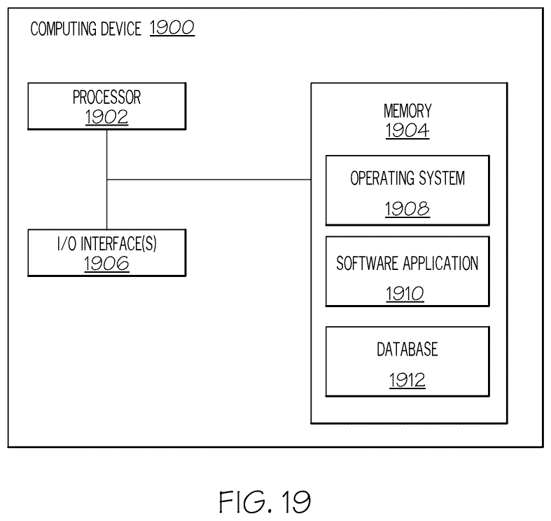

FIG. 19 depicts a diagram of an example computing device, according to an example embodiment. As shown, the computing device 1900 includes one or more processors 1902, non-transitory computer readable medium or memory 1904, I/O interface devices 1906 (e.g., wireless communications, etc.) and a network interface 1908. The computer readable medium 1904 may include an operating system 1908, running one or more software applications 1910 in accordance with the systems and methods described herein.

In operation, the processor 1902 may execute the application 1910 stored in the computer readable medium 1904. The application 1910 may include software instructions that, when executed by the processor, cause the processor to perform operations for responding to a threat, as described and shown in the various Figures.

The application program 1910 may operate in conjunction with the data section 1912 and the operating system 1908. The device 1900 may communicate with other devices (e.g., a wireless access point) via the I/O interfaces 1906.

Although the foregoing figures illustrate various embodiments of the disclosed systems and methods, additional and/or alternative embodiments are contemplated as falling within the scope of this disclosure. For example, in one embodiment, this disclosure provides for a method (and/or associated computer systems and computer program products) for responding to threats. The method includes receiving, by a firewall of a monitored network system, network traffic, providing, by the firewall, filtered metadata associated with a portion of the network traffic to a remote machine learning model for analysis, receiving, by the firewall, a response from the remote machine learning model based on the analysis, and enforcing, by the firewall, the response from the remote machine learning model on the received network traffic with an action.

In another embodiment, the receiving, by the firewall, the response from the remote machine learning model based on the analysis further includes receiving, by the firewall, a risk score indicating an indicator of compromise associated with the portion of the network traffic from the remote machine learning model.

In yet another embodiment, the method includes creating, by the firewall, a temporary risk score Json file associated with the received risk score.

In yet a further embodiment, the method includes updating, by the firewall, a master indicator of compromise list stored in the firewall with the received risk score when the received risk score is equal or higher than an existing risk score associated with the indicator of compromise.

In another embodiment, the method includes adding, by the firewall, the received risk score associated with the portion of the network traffic to the master list stored in the firewall when the indicator of compromise is not found on the master list.

In a further embodiment, the method includes cleaning, by the firewall with a time to live (TTL) based cleanup mechanism, a master indicator of compromise list after receiving the risk score from the remote machine learning model.

In yet another embodiment, the method includes taking an action, by the firewall, on the network traffic associated with the indicator of compromise based on the received risk score associated with processing options, wherein the taking the action includes at least one of “logging” and “logging and dropping”.

In yet a further embodiment, the method includes providing, by the firewall, a management user interface configured to receive configuration selections from an administrator, the configuration selections related to associating the received risk scores from the remote machine learning model with the taking the action; and receiving, by the firewall, a change in configuration selections from the administrator using the management user interface.

In another embodiment, the method includes validating and storing, by the firewall, the received change in configuration selections in a configuration database of the firewall.

In yet another embodiment, the method includes extracting, by the firewall, the filtered metadata associated with the network traffic, and performing, by the firewall, one or more threat analyses on the network traffic asynchronously with the analysis by the remote machine learning model after the extracting the filtered metadata.

In another embodiment, the present disclosure provides for a method (and/or associated computer systems and computer program products) for responding to threat that includes receiving, by a firewall of a monitored network system, network traffic, extracting, by the firewall, metadata associated with the network traffic, providing, by the firewall, the metadata associated with the network traffic to a machine learning model for the analysis, receiving, by the firewall, a response from the machine learning model based on the analysis, performing, by the firewall, one or more threat analyses on the network traffic asynchronously with the analysis by the remote machine learning model, and enforcing, by the firewall, the response from the remote machine learning model on the received network traffic with an action.

In another embodiment, the performing, by the firewall, the one or more threat analyses on the network traffic further includes performing, by the firewall, a local indicator of compromise lookup.

In a further embodiment, the one or more threat analyses on the network traffic further includes performing, by the firewall, a plurality of separate threat analyses using a plurality of separate threat feed databases.

In yet another embodiment, the action includes at least one of “logging” and “logging and dropping”.

In yet a further embodiment, the receiving, by the firewall, the response from the remote machine learning model based on the analysis further includes receiving, by the firewall, a risk score indicating an indicator of compromise associated with the network traffic from the remote machine learning model.

In another embodiment, the method includes creating, by the firewall, a temporary risk score Json file associated with the received risk score.

In a further embodiment, the method includes updating, by the firewall, a master indicator of compromise list stored in the firewall with the received risk score when the received risk score is equal or higher than an existing risk score associated with the indicator of compromise.

In yet another embodiment, the method includes adding, by the firewall, the received risk score associated with the network traffic to the master list stored in the firewall when the indicator of compromise is not found on the master list.

In yet a further embodiment, the method includes cleaning, by the firewall with a time to live (TTL) based cleanup mechanism, a master indicator of compromise list after receiving the risk score from the remote machine learning model.

In another embodiment, the method includes taking an action, by the firewall, on the network traffic associated with the indicator of compromise based on the received risk score associated with processing options, wherein the taking the action includes at least one of “logging” and “logging and dropping”.

In another embodiment, the present disclosure provides for a method (and/or associated computer systems and computer program products) for responding to threat that includes receiving, by a firewall of a monitored network system, network traffic, inline preparing, by a packet analysis system located within the firewall, flow metadata associated with the network traffic, providing, by the packet analysis system, the network traffic to the firewall for further processing after the inline preparing, providing, by the firewall, the prepared flow metadata associated with the network traffic to a remote machine learning model for analysis, and receiving, by the firewall, a response from the machine learning model based on the analysis.

In another embodiment, the method includes processing, by a fast path processing system operating within the firewall, the network traffic, and accelerating, by the fast path processing system operating within the firewall, the network traffic.

In a further embodiment, the inline preparing, by the packet analysis system located within the firewall, the flow metadata associated with the network traffic includes preparing the flow metadata without replication of the network traffic.

In yet another embodiment, the inline preparing, by the packet analysis system located within the firewall, the flow metadata associated with the network traffic includes generating a flow table associated with the network traffic.

In yet a further embodiment, the inline preparing, by the packet analysis system located within the firewall, the flow metadata associated with the network traffic includes performing deep packet inspection on the network traffic.

In another embodiment, the performing deep packet inspection includes populating the flow table with the flow metadata.

In a further embodiment, the populating the flow table with the flow metadata includes performing memory pool callbacks for allocating entries in the flow table and memory callbacks for allocating and freeing heap memory.

In yet another embodiment, the method includes determining, by a threat intelligence filter, a first portion of the prepared flow metadata that is not needed for machine learning processing and a second portion of the prepared flow metadata to be provided for machine learning processing, and filtering, by a threat intelligence filter, the prepared flow metadata associated with the network traffic into the first and second portions, where the providing, by the firewall, the prepared flow metadata associated with the network traffic to the remote machine learning model for inline analysis in real time includes providing only second portion of the prepared flow metadata.

In yet a further embodiment, the flow metadata includes a plurality of metadata fields, wherein the plurality of metadata fields includes at least two fields selected from the group consisting of an array of transmission control protocol (TCP) segment lengths of a connection, a hostname, a cluster hash for associating flows, a deep packet inspection extracted string, a deep packet inspection calculated flow risk flag, a popularity flag, a flow duration, IP information, port information, and protocol information.

In another embodiment, the method includes creating, by the firewall, multiple instances of the packet analysis system to allow concurrent processing for unrelated traffic flows.

In another embodiment, the present disclosure provides for a method (and/or associated computer systems and computer program products) for responding to threat that includes receiving, by a firewall of a monitored network system, network traffic, processing, by the firewall, the network traffic using a fast path processing system, accelerating, by the fast path processing system, the network traffic, preparing, by a packet analysis system located within the firewall, flow metadata associated with the network traffic, providing, by the firewall, the prepared flow metadata to a machine learning model for analysis, and receiving, by the firewall, a response from the machine learning model based on the analysis.

In another embodiment, the method includes determining, by a threat intelligence filter, a first portion of the prepared flow metadata that is not needed for machine learning processing and a second portion of the prepared flow metadata to be provided for machine learning processing, and filtering, by a threat intelligence filter, the prepared flow metadata associated with the network traffic into the first and second portions, where the providing, by the firewall, the prepared flow metadata associated with the network traffic to the remote machine learning model for analysis includes providing only second portion of the prepared flow metadata.

In a further embodiment, the preparing, by the packet analysis system located within the firewall, the flow metadata associated with the network traffic includes preparing the flow metadata without replication.

In yet another embodiment, the preparing, by the packet analysis system located within the firewall, the flow metadata associated with the network traffic includes generating a flow table associated with the network traffic.

In yet a further embodiment, the preparing, by the packet analysis system located within the firewall, the flow metadata associated with the network traffic includes performing deep packet inspection on the network traffic.

In another embodiment, the performing deep packet inspection includes populating the flow table with the flow metadata.

In a further embodiment, the populating the flow table with the flow metadata includes performing memory pool callbacks for allocating entries in the flow table and memory callbacks for allocating and freeing heap memory.

In yet another embodiment, the flow metadata includes a plurality of metadata fields, wherein the plurality of metadata fields includes at least two fields selected from the group consisting of an array of transmission control protocol (TCP) segment lengths of a connection, a hostname, a cluster hash for associating flows, a deep packet inspection extracted string, a deep packet inspection calculated flow risk flag, a popularity flag, a flow duration, IP information, port information, and protocol information.

In yet a further embodiment, the method includes creating, by the firewall, multiple instances of the packet analysis system to allow concurrent processing for unrelated traffic flow.

In another embodiment, the packet analysis system is configured to prepare the flow metadata using a poll mode and an event mode.

Accordingly, the foregoing systems and methods present technologically beneficial approach to addressing the problem of incorporating ML threat processing of network traffic at the firewall level. In particular, the systems and methods address a further problem of how to process network traffic at a remote ML system in real time without slowing the overall network traffic processing. This is accomplished through asynchronous processing of network traffic in the described manner while the ML system is performing ML analysis. Still further, the systems and methods address the problem of how to reduce the overall processing requirements at the firewall level by incorporating the remote ML processing in a cloud system in communication with the firewall. Still further, the systems and methods address the problem of how to perform efficient remote ML processing of threats on network traffic. This is accomplished by filtering out the metadata of the received network traffic at the firewall level and only providing metadata associated with network traffic that the firewall determines machine learning analysis would be helpful and/or appropriate. Still further, systems and methods address the problem of how to ensure fast processing of the network traffic for metadata filtering, which is accomplished by including a fast path system to allow for inline metadata processing.

It will be appreciated that the modules, processes, systems, and sections described above may be implemented in hardware, hardware programmed by software, software instructions stored on a nontransitory computer readable medium or a combination of the above. A system as described above, for example, may include a processor configured to execute a sequence of programmed instructions stored on a nontransitory computer readable medium. For example, the processor may include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions may be compiled from source code instructions provided in accordance with a programming language such as Java, C, C++, C #. net, assembly or the like. The instructions may also comprise code and data objects provided in accordance with, for example, the Visual Basic™ language, or another structured or object-oriented programming language. The sequence of programmed instructions, or programmable logic device configuration software, and data associated therewith may be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections may be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above may be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein may be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that may be used on a variety of computer platforms. Alternatively, embodiments of the disclosed method, system, and computer program product may be implemented partially or fully in hardware using, for example, standard logic circuits or a VLSI design. Other hardware or software may be used to implement embodiments depending on the speed and/or efficiency requirements of the systems, the particular function, and/or particular software or hardware system, microprocessor, or microcomputer being utilized. Embodiments of the method, system, and computer program product may be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) may be implemented in software executed on a programmed general purpose computer, a special purpose computer, a microprocessor, a network server or switch, or the like.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter. It should also be understood that references to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

1. A method for responding to a threat comprising:
receiving, by a firewall of a monitored network system, network traffic;
providing, by the firewall, filtered metadata associated with a portion of the network traffic to a remote machine learning model for analysis;
receiving, by the firewall, a response from the remote machine learning model based on the analysis; and
enforcing, by the firewall, the response from the remote machine learning model on the received network traffic with an action.

2. The method of claim 1, wherein the receiving, by the firewall, the response from the remote machine learning model based on the analysis further comprises:
receiving, by the firewall, a risk score indicating an indicator of compromise associated with the portion of the network traffic from the remote machine learning model.

3. The method of claim 2, further comprising:
creating, by the firewall, a temporary risk score Json file associated with the received risk score.

4. The method of claim 2, further comprising:
updating, by the firewall, a master indicator of compromise list stored in the firewall with the received risk score when the received risk score is equal or higher than an existing risk score associated with the indicator of compromise.

5. The method of claim 2, further comprising:
adding, by the firewall, the received risk score associated with the portion of the network traffic to the master list stored in the firewall when the indicator of compromise is not found on the master list.

6. The method of claim 2, further comprising:
cleaning, by the firewall with a time to live (TTL) based cleanup mechanism, a master indicator of compromise list after receiving the risk score from the remote machine learning model.

7. The method of claim 2, further comprising:
taking an action, by the firewall, on the network traffic associated with the indicator of compromise based on the received risk score associated with processing options, wherein the taking the action includes at least one of “logging” and “logging and dropping”.

8. The method of claim 6, further comprising:
providing, by the firewall, a management user interface configured to receive configuration selections from an administrator, the configuration selections related to associating the received risk scores from the remote machine learning model with the taking the action; and
receiving, by the firewall, a change in configuration selections from the administrator using the management user interface.

9. The method of claim 6, further comprising:
validating and storing, by the firewall, the received change in configuration selections in a configuration database of the firewall.

10. The method of claim 1, further comprising:
extracting, by the firewall, the filtered metadata associated with the network traffic; and
performing, by the firewall, one or more threat analyses on the network traffic asynchronously with the analysis by the remote machine learning model after the extracting the filtered metadata.

11. A method for responding to a threat comprising:
receiving, by a firewall of a monitored network system, network traffic;
extracting, by the firewall, metadata associated with the network traffic;
providing, by the firewall, the metadata associated with the network traffic to a machine learning model for the analysis;
receiving, by the firewall, a response from the machine learning model based on the analysis;
performing, by the firewall, one or more threat analyses on the network traffic asynchronously with the analysis by the remote machine learning model; and
enforcing, by the firewall, the response from the remote machine learning model on the received network traffic with an action.

12. The method of claim 11, wherein the performing, by the firewall, the one or more threat analyses on the network traffic further comprises:
performing, by the firewall, a local indicator of compromise lookup.

13. The method of claim 11, wherein the one or more threat analyses on the network traffic further comprises:
performing, by the firewall, a plurality of separate threat analyses using a plurality of separate threat feed databases.

14. The method of claim 11, wherein the action includes at least one of “logging” and “logging and dropping”.

15. The method of claim 11, wherein the receiving, by the firewall, the response from the remote machine learning model based on the analysis further comprises:
receiving, by the firewall, a risk score indicating an indicator of compromise associated with the network traffic from the remote machine learning model.

16. The method of claim 15, further comprising:
creating, by the firewall, a temporary risk score Json file associated with the received risk score.

17. The method of claim 15, further comprising:
updating, by the firewall, a master indicator of compromise list stored in the firewall with the received risk score when the received risk score is equal or higher than an existing risk score associated with the indicator of compromise.

18. The method of claim 15, further comprising:
adding, by the firewall, the received risk score associated with the network traffic to the master list stored in the firewall when the indicator of compromise is not found on the master list.

19. The method of claim 15, further comprising:
cleaning, by the firewall with a time to live (TTL) based cleanup mechanism, a master indicator of compromise list after receiving the risk score from the remote machine learning model.

20. A firewall system, comprising:
one or more processors;
one or more computer readable storage media; and
computer readable code stored collectively in the one or more computer readable storage media, with the computer readable code including data and instructions to cause the one or more computer processors to perform a method for responding to a threat comprising:
receiving, by the firewall system, network traffic;
providing, by the firewall system, filtered metadata associated with a portion of the network traffic to a remote machine learning model for analysis;
receiving, by the firewall system, a response from the remote machine learning model based on the analysis; and
enforcing, by the firewall, the response from the remote machine learning model on the received network traffic with an action.
